(19) United States
(12) Patent Application Publication
(10) Pub. No.: US 2015/0356088 A1
(43) Pub. Date: Dec. 10, 2015

(54) TILE-BASED GEOCODER

(71) Applicant: Microsoft Corporation, Redmond, WA (US)

(72) Inventors: Pavel Berkhin, Sunnyvale, CA (US); Florin Teodorescu, Redmond, WA (US); Bimal Mehta, Sammamish, WA (US); Andrew P. Oakley, Seattle, WA (US); Erik C. Wahlstrom, Seattle, WA (US); David L. Racz, Palo Alto, CA (US); Anurag Sharma, Woodinville, WA (US); Michael R. Evans, Sunnyvale, CA (US)

(73) Assignee: MICROSOFT CORPORATION, Redmond, WA (US)

(21) Appl. No.: 14/298,857

(22) Filed: Jun. 6, 2014

(51) Int. Cl. G06F 17/30

(52) U.S. Cl. CPC G06F 17/3053; G06F 17/3002; G06F 17/30061; G06F 17/30241

(57) ABSTRACT

A geocoding architecture that generates and associates one or more tile documents with geocoded tiles. When connected entities are defined, the connected entity attributes are collected in a single tile document so that tile-document terms are attributes of all connected entities. These terms later serve as keys that enable search for tiles relevant for a given query. Entity documents are created that are an aggregation of entity attributes. Like the entity document, the tile document serves as an aggregator for all the geospatial entities within a pre-determined surface area. Search is then performed on the content of tile and entity documents.

### BACKGROUND

A goal of a geocoder (GC) is to find a map location and return an appropriate spatial representation of this geographical location, and potentially, together with object(s) that correspond to the location. People indicate locations in many different ways and tradition varies from country to country. In many western countries colloquial addresses follow some hierarchical containment logic such as street, city, county, state (though many fields can be missed). In principle, such addressing attempts to point to a single (maybe non-existent) entity. In contrast, colloquial addresses of other countries are based on landmarks, following directional logic.

Traditionally, map user intent is divided into business, place, and address inquiries. However, demarcation between a place and an address query is vague at best. Indeed, zip-codes, cities, and landmarks that are usually considered to be places simultaneously serve as parts of address queries.

In addition, many geocoder queries point to a location by several entities (e.g., “gas station near Bravern plaza”). Thus, a difficult problem quickly arises where not only is it a technical challenge to find entities that match query terms, but also among the myriad query term combinations there is further a challenge to obtain the entities that may be collocated.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture is a geocoding architecture that generates and associates multiple entities (e.g., streets, restaurants, points of interest, etc.) with geocoded tiles. The different kinds of entities are treated uniformly. The architecture can be manifested as a geocoder service (GCS). The surface area of the earth is modeled as a grid of adjusted tiles. A tile is square of a particular size (dimensions). The system of tiles covers all earth and tiles overlap in such way that every two points with within a unit distance one from another belong to at least one tile. To each tile are connected all entities that intersect the tile. An entity is treated as a textual document (e.g., title and address of a school). When connected entities are defined, the connected entity documents are collected in a single tile document so that tile-document terms become the embracing tile terms. These terms can later serve as keys (e.g., in an inverted index) that enable search for tiles relevant for a given query.

Tile identifiers (IDs) are further used as additional query input terms to resolve a query to appropriate co-located entities. Determining these entities can be accomplished through inverted indexes built on entity documents. Each entity document contains an aggregation of entity's attributes. Similar to the entity document, the tile document serves as an aggregator for all the geospatial entity terms within a predetermined surface area. Searching is then performed on the content of tile documents and entity documents.

As described, a geocoding tile is represented by its tile document. The tile document captures all relevant attributes (terms) of the entities connected with the tile. If an attribute is present, the attribute can serve as indexation term (e.g., in inverted index). Thus, a tile search index is created and updated of the tile documents. Entities are represented by an entity documents, which is also indexed in an entity search index. The entity documents capture all relevant attributes of the entity, along with references to the tiles with which the entity is connected (intersections with the tile or is located in the tile's close proximity).

The architecture utilizes search technology to resolve a query in a corpus of tiles, thus locating the potential candidate tiles most likely referenced by the query. Additionally, the search technology resolves the query—augmented with the tile ID(s) determined previously—in the corpus of entities, thus, scoping down the result to the entities most relevant for the query. Certain high-profile entities may be indexed separately enabling a more direct and immediate resolution of queries with popular terms.

More specifically, when received, a query is analyzed. The query can be interpreted in several ways (e.g., stop words can be deleted). A separate search is then initiated for the most promising query interpretations. In other words, query rewriting is utilized. Term semantics can also be utilized. Thus, a query can be thought as a sequence of query terms each comprising a one or more tokens (e.g., bi-gram “New York”).

At runtime, after the query is analyzed, and for each query interpretation, at least two queries can be executed:a call to database of entities (e.g., roads, businesses, places, etc.) to find a potential good match, and a search for several entities (an entity set) (assuming that no entity is a good match).

Query completion is accomplished by (a) finding a tile that represents a concept of collocation and (b) finding an entity set. Therefore, in (a), a tile is searched that matches the best query terms. The matching involves term frequency calculations of double or triple terms in close proximity, and other techniques. To do so, a search is issued to the set of all tile documents, using standard search technology (e.g., that can utilize an inverted index of tiles). The potential candidates that emerge are ranked to find one or several of the best potential candidates.

Given the optimum potential tile candidates, one or more entities can be searched. A goal is to find one or several entities that match the query among the entities connected to a tile. For example, there are numerous “Farmer Markets”, “Market streets”, and “Embarcadero” in the world. However, there is only one Farmer Market, one Market Street, and one “Embarcadero” when collocated together and in a tile located in downtown San Francisco. The GCS can return some geographic object, such as a pushpin, but in principle, a polygon.

For each query interpretation several partially matching tiles may be discovered, and for each such tile several entity sets may be discovered. Ranking is employed to select one (or several) of the most probable entity sets, from which a final GCS result is constructed.

Relevance ranking can rely on a variety of features that model several factors. The factors can include core relevance and geo-relevance (geographic relevance). Core relevance considers the similarity of textual query to attributes of found entities, popularities of entities in an entity set, and to the consistency between the entities. For example, consider a query “Geary and Franklin” issued by a user located in San Francisco. One particular result can comprise of two entities; “Geary Blvd.” and “Franklin Street”, which intersect. Another result can consist of two other entities: “Geary Public Parking” and “First Franklin Bank”. Both results consist of two entities, and both entities match both terms of a query, yet the first result appears a better match, because two streets indeed intersect. The geo-relevance factor takes into consideration features such as distance from a viewport, distance from user location, prominence of a surrounding place, mutual collocation of entities found, and so on. The ranked results are then returned to the user.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates a flow diagram of a tile-based geocoder service in accordance with the disclosed architecture.

FIG. 3 illustrates is a general flow diagram of the online execution algorithm of the geocoder service.

FIG. 4 illustrates a tile system of overlapping tiles for the tile geocoding service.

FIG. 5 illustrates a tile system of different sized overlapping tiles for different densities, importance, and/or popularity of entities.

FIG. 6 illustrates a tile diagram of hierarchical tile organization and keys.

FIG. 7 illustrates a tile diagram where entities of higher importance or popularity are pyramided into a single larger tile.

FIG. 8 illustrates a system where relationships are stored in a tile document.

FIG. 9 illustrates an exemplary tile document.

FIG. 10 illustrates a system of query enrichment.

FIG. 11 illustrates an index search system.

FIG. 12 illustrates a flow diagram of an offline execution phase of the geocoder service.

FIG. 13 illustrates a method in accordance with the disclosed architecture.

FIG. 14 illustrates an alternative method in accordance with the disclosed architecture.

FIG. 15 illustrates a block diagram of a computing system that executes the geocode service in accordance with the disclosed architecture.

### DETAILED DESCRIPTION

The disclosed architecture comprises a service (referred to as a geocoder service (GCS)) that accepts a geocode (GC) query which intends to find a map location, and to return an appropriate spatial representation of this location, along with any corresponding entity(s). The GCS utilizes search technology, does not require expensive geometric calculations online, and is open to machine learning. The GCS exploits the collocation of entities by pre-indexing the entities in a coarse geospatial grid, or tiles, and then employing search technology in a corpus of tiles. Additionally, basic market-specific grammar analysis can be used across different markets.

Generally, once a query is received (e.g., from the user), potential candidate tiles are discovered based on query analysis. Collocated entities connected to a single tile are then discovered from the tiles. Results are constructed from the discovered entities, and the results are ranked and returned to the user. More detailed aspects of this process relate to query enrichment (or augmentation) phase that generates several alternative queries. The alternative queries are then searched over different corpuses in an index search phase. The results are then post-processed (also referred to a query completion). Post-processing of the results includes ranking the different results (if the results are determined to be highly relevant, further search is terminated and flow returns) and interpolation (if addresses include street numbers that are absent in point addresses, then the location can be found via interpolation).

The GCS input comprises a textual query, a viewport, and a user location. At runtime, a textual query is always present, a viewport is usually present (but sometimes as a default value not set by the user), and a user location is optional. Other elements of context (e.g., language) may also be present.

People indicate locations in many different ways and tradition varies from country to country. In many western states colloquial addresses follow some hierarchical containment logic (e.g., street, city, county, state (though many fields can be missed)). In principle, such addressing tries to point to a single (maybe non-existent) entity. In some foreign countries colloquial addresses are based on landmarks, following directional logic. These are conjunction queries pointing to multiple entities. For example, address queries typical for Bangalore, India can include:

233 10th cross rajajinagar 1st N block, near vidyar vardhaka sanghahar

#5 “srinidhirst” 4th main srikantheshwar nagar, near mahalakshmi layout bus stop, Bangalore

446 6th main 110th cross shastry nagara Bangalore 566728

#38/7, Magadi Center Road, Jaimuni Rao Circle, AD Hallihali, Bangalore-563479

316427, 15th block, 4rd floor, Janapriya Township, Magradian Road

Multi-pointing is advantageous in some geographical markets where even a formal address can resemble “Sunview A1 Behind Only Parath Hotel, Opposite Amchi Shala, Tilak Nagar, Kajupada Road, Chembur”. A somewhat more universal example of a multi-pointer GC query, applicable to any market, is “gas station near Lombard and Geary”. When pointing to several collocated entities, the GC query can also contain qualifiers such as “near”, “around”, “behind”, and so on.

In GCS search, a query can point to more than one entity (e.g., the intersection of two streets, where each street is an entity). Therefore, the GCS search is not confined to one entity (a document) but to a set of entities related by a condition to be spatially close to each other. Search engines typically do not implement the concept of entity joins. Consequently, a new approach is implemented where a GC query that points to several collocated entities is referred to as a multi-pointer query.

There are at least two major scenarios for invocation of a GC (geocoder): the user describes an address as a free text (an unstructured address) and a system/pipeline tries to qualify terms of a query as city, street name, etc. (a structured query). The “structure” supplied by an upstream application can be unreliable (e.g., City=“Seattle, Wash.” instead of City=“Seattle”). Additionally, the structure depends on a market, for example, in France, a street type precedes a street name (e.g., “Rue de Berri”) and in Russia a house number follows a street name (e.g., “ [symbol] 73”), while in USA both orders are reversed (e.g., “3120 Main St”).

A first step is to analyze the query using a general grammar analysis. Query terms are split into a sequence of tokens. Most frequently, such a split (a query rewrite or query interpretation) can be performed in a variety of ways. Then a separate search is performed initiated for every potential split, relying on, for example, in-index synonyms and alternatives. If the semantics (e.g., from an unquestionably confident structured call) of a particular term known, this can be used (e.g., City:Seattle as opposed to just Seattle that can be name of a street). As a result, a query can be thought as a sequence of query terms q=(t₁, . . . , tₚ) each consisting of one or more tokens (e.g., bi-gram “New York”).

The GCS output comprises a specific location to which a query refers, and one or more entities that are associated with this location. A geo-entity is defined by two types of data: textual data, and a geometry object. An entity is a point entity if its geometry is represented by a single point (e.g., latitude and longitude). An extended entity has geometry represented by polygons or polylines, which in turn are represented by multiple connected points. A combination of points, polygons, or polylines can be collectively referred to as a spatial shape. Spatial shapes may be represented by a point, or a natural representation. An intended spatial form representation is referred to as a location, which in most cases is a point within a bounding box. A location is not necessarily small—it can be a city or a region, for example.

With respect to the second GCS output (one or more entities that are associated with this location), frequently, a GCS query points to a particular place, business, or point address. In this case, a single entity is returned and its geometry (a spatial shape) defines the location. In other cases, a location cannot be identified with an entity. For example, a particular house address may not be present in a database of point addresses, in which case an interpolated location is used and a street is returned as a matter of convenience.

Another example is the intersection of two streets not present as an independent entity in a database. In such cases, the location is defined by the intersection of two polylines and both road entities are returned. Alternative implementations may extend this concept by adding extra dimensions to the location to accommodate for three-dimensional (3D) environment such as subways, high-rise apartments, or shopping malls. As customary in search engines, when in doubt, the GCS can return more than one result (e.g., location+entities).

The scenarios for invocation of the GCS include structured and unstructured queries. For example, a user free-text query for an address is considered an unstructured address and a system/pipeline query which qualifies terms of a query as a city, a street and so on, is considered a structured query.

A query is considered a GC query if the query comprises one or more pointers to a specific map location (considering more general queries as map search queries). For example, an address query “40 22^{nd} Avenue, San Francisco” points to a street house number, to a street name, and to a city, and thus, it considered to be a GC query. The target location is a point address; however, a GC query can also point to a business, a place, or a larger area, such as a city neighborhood (e.g., “SOMA San Francisco”).

The disclosed architecture does not distinguish between query location pointers to addresses, places, or businesses, etc. Moreover, the types of data pointing can be extended beyond a location. For example, consider an aspirational example of a query “Caravaggio near Piazza Navona” that would return a location of the church “San Luigi dei Francesi” near Piazza Navona in Rome, which contains a painting by the artist Caravaggio. Using conventional systems, this query returns the hotel “Caravaggio”, which is far from Piazza Navona.

Queries such as a category query (e.g., “restaurants in Chicago”) and a routing query can be considered as more general map search queries. The first query points to a category of objects within a viewport. The second query has a task to find directions. None of these queries points to a specific location, and thus, may require additional processing.

With respect to multi-pointer queries, GC query terms point to an entity attribute: postal code, road name, business name, etc. What differentiates GC search from existing search is that in regular search, query terms are matched as much as possible to a single document in the corpus. Because of uncertainty, several such documents, all independently retrieved by relevance to the query, are suggested to the user.

Following are notations and definitions that may be used herein to describe the disclosed architecture.

An Entity (e) is a geo-entity which is an object that is characterized by its text (elements of text are addressed as terms or attributes) and geometry; usually a road, a place or a business.

A point entity is an entity with a geometry represented by one point.

An extended entity is an entity with a geometry represented by polyline or polygon.

A B-tile (T) is a GC tile that conceptually consists of entities E(T) and associated concatenated texts. Tile size can be vary; a tile assembles its entities that intersect with the tile along with its N-, E-, and NE-neighbors, which de-facto provides for overlapping. Such entities are referred to as being “connected to a tile”.

An H-tile (H) is an element of a hierarchy of large tiles; IDs are used for tagging B-tiles or entities to enable local search around a viewport or user location.

Query (Q=(q₁, q₂, . . . , qₖ)) is unstructured short text consisting of terms qᵢ

A viewport is a bounding box showing a portion of a map in a user experience.

A spatial shape is a line, polygon, polyline or approximation thereof

A location is a representation of a spatial shape.

Qualifiers are query terms such as “near”, “around”, “behind”, etc.

A flat index is an arranged logical concatenation of all document texts in the corpus.

A forward index is a per-document index (PDI) representing a document text.

A T-term is a word term used in description of large administrative areas, e.g., a city or state name or a postal code.

An E-term is any entity text terms (other than T-terms) in their addresses.

freq(q, e) are the number of times term q occurs in entity e.

The disclosed GCS comprises a new algorithm that utilizes a traditional search stack, does not require expensive geometric calculations online, and is capable of finding multiple collocated entities. The GCS utilizes a new variant of a geometric intersection geocoder (or spatial geocoder).

The GCS finds multiple collocated entities pointed-to by an unstructured query. While a traditional geometric intersection geocoder abandons exploration of intricate grammars in favor of geometric explorations, the GCS readmits universal grammar analysis (to some degree confined to regular query processing) to separate qualifiers from entity pointing terms and to determine “T-terms”.

After determining the query terms, the GCS delays search for entities until the common location (at a coarse level of a tile) is found, which simplifies eventual search for entities. Additionally, the GCS utilizes traditional search to operate on a new aspect referred to as a tile document. Each tile has an associated tile document. For example, if the geometric object representing “Lake Tahoe” intersects with a tile T, it will be included in a logical construct E (T) (a set of connected entities) and the text “Lake Tahoe, Calif.” will be added to the tile document. The description herein does not, in every instance, distinguish between a tile and its associated textual tile document.

Concatenation of different entity texts together in a tile document makes search for multi-pointer queries feasible. For example, if two roads intersect within a tile and a query contains sufficient elements of the road names, the tile is identified. While many street names are commonly-used all over the world, resulting in a large number of potential candidate pairs, the tile containing their intersection contains both names, and therefore, the number of such potential tiles is much smaller.

It is to be understood that entities do not need to physically intersect, but can simply be geographically close to each other. When a tile is found, the problem of finding specific entities within this tile is a tractable job, since it is confined to a tiny fraction of the overall entity corpus.

The disclosed architecture in one implementation utilizes a two-step approach. For a query Q={q₁, . . . , qₖ):

1. Find a tile T relevant to a query: {q₁, . . . , qₖ}⊂T, and

2. Find an entity or entities located within the tile e₁εE (T), . . . , eₛεE(T) that optimally matches the query q₁, . . . , qᵢ_{₁}εe₁, qᵢ_{₁}₊₁, . . . , qᵢ_{₁}₊ᵢ_{₂}εe₂, . . . , qₖεeₛ. (Note that partial matches are also allowed.)

There is no need physically to maintain the logical construct E (T). Rather, entities connected with tile T can be marked by a tile ID (identifier) meta-term. This makes the search in the second step above to appear similar to a classic search for an augmented query Q′=(Q, T), when s=1.

In one example implementation, the B-tile (or referred to more generally herein as “tile”) can be a map tile with dimensions of approximately 1.2 km×1.2 km (kilometers) (e.g., at the equator). This provides a reasonable scale for the concept of proximity. While 1 km proximity is a reasonable scale for proximity, two very close entities can be located on two sides of a tile boundary. This provides motivation to deal with overlapping 2 km×2 km tiles, since these tiles guarantee that entities located within 1 km distance will end up in one such tile.

Rather than physically constructing and enumerating overlapping tiles, one level of detail for tile identification is utilized and a tile entity set E(T) of entities that intersect with the actual tile A, as well as with the associated three neighboring tiles: a North-neighboring tile (N), an East-neighboring tile (E), and a NE-neighboring tile (NE), are included in the tile document associated with the actual tile A. In this way, de-facto B-tile overlapping tiles of a reduced amount of detail are obtained, but enumerated by the higher level of detail quadkeys.

Following is a description of tile ranking Approaches for tile enumeration include tile prominence, data partitioning, and local search. To sort tiles according to tile prominence includes a defined static rank reflecting popularity and other features of entities in the tile. Data partitioning for offline device execution means that the world can be divided into some predefined zones and the GCS index data can be partitioned by the zone. With respect to local search, since many tile searches are focused using user location and viewport, it is useful to consider locality when enumerating tiles.

With respect to entity area, an entity connects to all level-tiles with which it intersects geospatially. In addition, the entity also connects to all the tiles neighboring the intersecting tiles on the N, E, and NE. This approach guarantees that any two entities within one unit of distance will be collocated in at least one tile (and at most four tiles), essentially creating overlapping tiles.

With respect to entity prominence, an entity can connect to larger size tiles (e.g., 8×8, 64×64, etc.) based on several rules. The largest tile to which an entity is connected defines its prominence. The following rules can be applied when determining the prominence of an entity.

In a first rule, if the frequency of some entity categories at a level-tile is smaller than a threshold, the related entities can have their prominence boosted such that they connect to the larger tile, and thus, become more “visible”. For instance, if within a kilometer (km) square tile (denoted as “1×1”) there is only one restaurant, the related entity is connected to the 8×8 tile; hence, allowing the 1×1 tile to be co-located with other entities within a 10 km radius. Queries such as “restaurants near xyz location” will then have a better chance to provide an answer given the increased geography of the scope.

In a second rule, entities with certain static characteristics such as cities with populations greater than N, interstate highways, hospitals, state parks, famous POI (points of interest), etc., can also have their prominence boosted, thereby increasing their visibility. In a third rule, entities with certain area span, such as covering a certain percentage of the larger tile surface, or intersecting a certain number of the level-tiles, can have their prominence boosted.

As a general rule, an entity connected to a larger tile can also be connected to all the smaller tiles within its spatial extent. The opposite is not true: an entity may be connected to a smaller tile (1×1) and not be connected to the larger tile. For example, if there are many gas stations within a square block (a 1×1 tile) the stations will not have to be represented at 10 km scale. The concept of “nearness” is thus flexible, within a range determined by the level-tile surface area and entity spatial and non-spatial characteristics.

In one implementation, it may be more convenient for the GCS to have a persisted representation of a geocode tile within the generator. Alternatively, the entity prominence and the connected tile can be computed at the moment when needed. Construction and updating of the geocode runtime indexes is described herein below.

With respect to constructing the geocode runtime indices, once the provider data drop is ingested into generator, the content change is reflected as a “change set” that captures the nature of the change such as the tile(s) impacted by the data drop and the entities added, removed, and updated through the data drop.

With respect to creating tile and entity search documents, these are the documents that are indexed into the tiles and entities corpuses, each being queried during the tiles search and entities search phases of the query resolution process.

For example, consider the hypothetical case of the following Table of geocode entities, all geo-located within one 1×1 tile (“023010203332110”). Each item has an identifier (ID), entity type, entity name, and address.

| ID | Entity Type | Entity Name | Address |
|---|---|---|---|
| A | Road | Geary Blvd. | Geary Blvd., SF, CA, USA |
| B | Business | Geary Theater | 123 Geary Blvd., SF, |
| | | | CA, USA |
| C | Hospital | Geary Pacific Hospital | 246 Post Str., SF, |
| | | | CA, USA |
| D | Road | Franklin Str. | Franklin Str., |
| | | | San Francisco, CA, USA |
| E | Business | 1^{st} Franklin Bank | 125 Geary Blvd., SF, |
| | | | CA, USA |
| F | Business | Geary and Franklin Stake | 777 Gough Str, SF, |
| | | House | CA, USA |

In this set context, the tile document constructed for “023010203332110” aggregates all attributes of the given entities. Following is an example of how this aggregation may work:

Each Entity Name is represented “as is” in the index, with handling to drop separators such as “.”:

[Geary Blvd],
[Geary Theater],
[Geary Pacific Hospital],
[Franklin Str],
[1st Franklin Bank],
[Geary and Franklin Stake House]

Each Entity Name is tokenized with well-known tokens and separators (e.g., “and”, “.”) stripped out:

[Geary],[Blvd],
[Geary],[Theater],
[Geary],[Pacific],[Hospital],
[Franklin],[Str],
[1st],[Franklin],[Bank],
[Geary],[Franklin],[Stake],[House]

Each Address is tokenized “intelligently”, for example, terms in-between separators such as “,” are then broken around specific keywords (e.g., house numbers, zip codes, “and” “x”); then separated at the word level:

```
    [Geary Blvd],[Geary],[Blvd],[SF],[CA],[USA],
    [123 Geary Blvd],[Geary Blvd],[Geary],[Blvd],[SF],[CA],[USA],
    [246 Post Str],[Post Str],[Post],[Str],[SF],[CA],[USA],
    [Franklin Str],[Franklin],[Str],[San
Francisco],[San],[Francisco],[CA],[USA],
    [125 Geary Blvd],[Geary Blvd],[Geary],[Blvd],[SF],[CA],[USA],
    [777 Gough Str],[Gough Str],[Gough],[Str],[SF],[CA],[USA]
```

The final tile document can then be a union of all these terms, with a rank reflecting their number of occurrences (in-between parenthesis):

```
    [Geary] (7)
    [CA] (6), [USA] (6)
    [SF] (5)
    [Str] (4), [Blvd] (4), [Geary Blvd] (4), [Franklin] (4),
    [Franklin Str] (2),
    [Geary Theater] (1), [Geary Pacific Hospital] (1),
    [1st Franklin Bank] (1), [Geary and Franklin Stake House] (1),
[Theater] (1),
    [Pacific] (1), [Hospital] (1), [1st] (1), [Bank] (1), [Stake] (1),
[House] (1),
    [San] (1), [Francisco] (1), [San Francisco] (1)
```

Note that the above is a simplified exemplification of tile document construction. In an extended version, this can capture in the index additional information about these terms, such as doubles, triples, etc. A similar mechanism can be employed when constructing each entity document.

The actual aggregation logic can be largely dependent on how structured the provider data may be. For instance, one template for an entity may impose that an address be structured at finer granularity, with distinct fields such as “Street Number”, “Street Name”, “City”, “Country”, etc. The more structured the provider data, the more straightforward the creation of the tile and entity documents. However, imposing excessive structure may limit the ability to engage the providers.

In the example above, for the ID (A), note that [Geary Blvd],[Geary],[Blvd] end up being counted twice, due to occurrence both in the Entity Name and in Entity Address fields. The provider data may be received/structured in such manner that special handling of fields and entity types may be needed. For instance, if Entity type is “Road”, find/look for duplicates in the Name and Address fields and reduce the number of occurrences of terms accordingly. There are no synonyms or variant names introduced at this level. These may be handled in the course of generating the query interpretations during Query Analysis Flow.

Having the tile and entity documents created, these documents are indexed in a respective corpus of tiles and a corpus of entities, which can be searched to resolve the user query into tiles, and then further into entities. Approaches for achieving this include, but are not limited to, utilizing an existing index search and building a new geospatial indexed search space. In this latter approach, an inverted index can be constructed in the tiles corpus, as well as an inverted index in the entities corpus. Since both are structurally and functionally equivalent, the same solution can be used.

One possible solution is to construct the inverted index as a radix prefix tree. Each of the colored nodes in this tree includes a reference to the tile (e.g., “023010203332110”) along with additional data supporting ranking, and so on. Extrapolating to the extent of the entire tiles corpus, each of the terms (entity attributes) contained across all tile documents has a node in this tree. The node references all the tiles for which the tile document is containing the respective term. Note that in order to resolve a query into the corpus of tiles, in this implementation, there is no need to physically build a tile document, but rather only to generate the inverted index described above. Searching in such an index returns the tile ID (quad address) which is the only one needed to further augment the query and issue the augmented query against the entities corpus.

With respect to query analysis flow, a query Q comprises a collection of n terms, and can also include additional information such as user location U, view-port V, market M, etc.:

Q={{q₁ . . . qₙ},U,V,M}

Initially, the incoming query is analyzed such that the most straightforward geospatial terms are detected and handled accordingly. This is the “Query Analysis” step. The end result of this step is to generate a ranked set of query interpretations:

Q→{Q₁ . . . Qₖ}

In addition, to produce the query interpretations, the query analysis is the decision factor between one or more execution flows described below.

With respect to a first query execution flow (Query→Entities), in cases of national markets, a large number of queries stand a higher chance of a direct resolution in the entities corpus via specialized indexes. Thus the query resolution can be expedited by directly searching the entities corpus, via the following example indexes of Businesses, Places, Roads, and Point addresses. This approach stands can return a set of entities with high ranks, thus shortcutting the more staged approach of reaching the same result via tiles.

With respect to a second query execution flow (Query→Tiles→Entities), in cases when the direct resolution of the query into entities from above does not produce quality results, the query interpretations can search in the tiles corpus, which further scopes down the search in the entities corpus. This more generic approach may be triggered in parallel to the direct resolution approach of letting a query completion phase analyze the responses and compose the final answer.

With respect to constructing the query Interpretations, each query interpretation carries through the information from the original query and has terms resulting from one or more of the following query tokenization, initial resolution of terms, and interpretation score.

Query tokenization:

. . . Canonicalization: “Apt 300, 1234 Redmond Way, 98052-2123”→“1234 Redmond Way 98052”

. . . Stemming: “Avenue”→“Ave”

. . . Lemmatisation: “Alki, Emerald City→“Alki, Seattle”

Initial resolution of well-known/special-meaning terms:

. . . Location: “Boston, Mass.” “City:Boston”

. . . Modifiers: “near”, “north”, etc. Impacting Query Tile resolution and Query completion phases;

. . . Non spatial attributes: “open late”, “kids friendly”

. . . Impacting filter/rank entity results;

. . . Determine if it is: “latitude/longitude”

Interpretation score:

. . . Decide the “quality score” for each interpretation

. . . Combine the query interpretation score into the final ranking (e.g., via math factorization)

The query analysis may result in advanced knowledge about some of the query terms. These may come from a small-size fast index giving the ability to qualify certain terms such as “Boston”→“City:Boston”, which leads to a quicker resolution and a higher level of accuracy of the result. Qualified terms may be resolved in the corpus of tiles and further in the corpus of entities, following the regular geocoding flow.

Below is an example on how a user query is used to produce various interpretations:

Q: “1 Lake Str. Oklahoma”
Q₁: “[Lake Street] [Oklahoma]” Score(Q₁) = 5
Q₂: “[Lake Street] [City: Oklahoma]” Score(Q₂)=3
Q₃: “[Lake Street] [State: Oklahoma]” Score(Q₃)=2
Q₄: “[First Lake Street] [Oklahoma]” Score(Q₄)=4
Q₅: “[First Lake] [Street of Oklahoma]” Score(Q₅)=1

With respect to query-to-tiles resolution, a geocode query processed through query analysis flow produces a set of query interpretations, each of which is resolved further in the corpus of tiles. This is the “Tiles Search” step. The end result of this step is to determine a ranked set of tiles, which are scoping down geospatially the intent of the user query:

Q→{T₁ . . . Tᵣ}

To reach to this end, the set of tiles is inferred from the ranked result of searching the selected query interpretations {Q₁ . . . Qₖ} into the corpus of tiles:

Qᵢ→{T₁ⁱ . . . Tᵣ_{ᵢ}ⁱ}

At this point, there are sets of tile sets, one set for each query interpretation. The union of all these sets represents the full geospatial extent applicable to the user query. The number of occurrences of certain tiles across these sets, combined with the original score of its query interpretation and the rank in each of its instances in the tile sets, are ultimately factored in the final tile rank. This enables a normalized ranking and the extraction of the final tiles set:

Rank({T₁¹ . . . Tᵣ_{₁}¹}∪ . . . ∪{T₁^{k} . . . Tᵣ_{ₖ}^{k}})→{T₁ . . . Tᵣ}

In order to merge the sets of tile sets into the final ranked set of tiles, the score calculated for each of the resulting tiles can be a simple factorization. For example, the score associated with each of the resulting tile can be conceptually represented as below:

$$Rank ( {T}_{i} ) = \frac{\sum Score ( {Q}_{i} ) * f ( Score ( {T}_{j}^{i} ) , U , V , M )}{k}$$

where i iterates through all query interpretations Qᵢ that produced a tile set containing Tₗ=Tⱼⁱ. Note the weight given to the score of the specific tile Score(Tⱼⁱ) takes into account the geospatial characteristics of the query, such as user location, viewport, market.

With respect to tile-to-entities resolution, having determined the target tiles, the original query is iteratively augmented with each of the resolved tiles, in their top-down ranking order. These queries are further resolved against the corpus of entities as below:

```
    1. foreach Tile Tᵢ in Resolved Tiles set {Tᵢ ... Tᵣ} do
    2. augment query Qᵢ = {{q₁ ... qₙ,Tᵢ},U,V,M}
    3. resolve Qᵢ in the corpus of Entities to a ranked set
{E₁ⁱ ... Eₚᵢⁱ}
    4. end
    5. merge all sets of entities into the final resolved entities
set {E₁ ... E_{Q}}
```

At step 3 above, the addition of the tile term Tᵢ to the query carries a specific meaning: the term is to be used in search as a “heavyweight” hint, thus scoping the result set only to the queries spatially related to the given tile. In the architectural diagram above, this logic is part of the “Entity Search” step and has the goal of using the tiles resolved in the previous step to scope down the most relevant set of entities applicable to the query.

Q→{T₁ . . . Tᵣ}→{E₁ . . . E_{q}}

Similar to the case of query-to-tiles resolution, deriving the final set of entities implies the calculation of a global rank for each entity, which takes into account originating tile rank and each individual score from the entity sets where the respective entity occurs.

With respect to relevance ranking of results and query completion, a single GC result (and multiple results are possible) can comprise one or more of the following[A1]:

A small bounding area on the map; polygon;

A pushpin; point;

An entity or entities within the area;

A qualitative measurement of the result, derived from the ranking score;

A descriptor; for example:
Intersection (for two streets), Address, etc.
Category or descriptive tag, e.g., Restaurant, for single entity,
Metadata for single entity
Area for multiple-entity pointers, and
Pushpin for addresses intersections or very small targeted locations.

Continuing with the example above, possible returns for a query “Geary and Franklin” with SF viewport cab be as follows: Query “Geary and Franklin” resolves to:

Entities: [Geary Blvd],[Franklin Str]→A point; Descriptors: Intersection, pushpin (relevance=Excellent)

Entity: [Geary & Franklin Stake House]→A point; Descriptor: Restaurant, pushpin, address, phone, etc. (relevance=Good)

Entities: [Geary Theater],[First Franklin Bank]→An enclosing area; Descriptors: area (relevance=Bad)

Ranking of potential results includes assessment of relevance of query interpretation, of tile search results, and of entity set results. Search ranking may usually be performed sequentially from cheap ranking to a more sophisticated final ranking

The computation of result relevance can be dependent on:

Query, viewport, user location, potentially other context elements such as the locale used when issuing the query

Type of return (intersection, entity, area with several entities, etc.)

Confidence score of a query interpretation leading to a tile

Ranking score of a tile leading to entities

Specifically, for the final set of entities, the following can apply:

Core relevance:
Similarity of a query string to terms of entities in results
Popularity of entities

Geo relevance:
Proximity of the result (area) to the viewport or user locations
Degree of co-location of entities in the result
Prominence of the place surrounding the result area

as well as other features.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

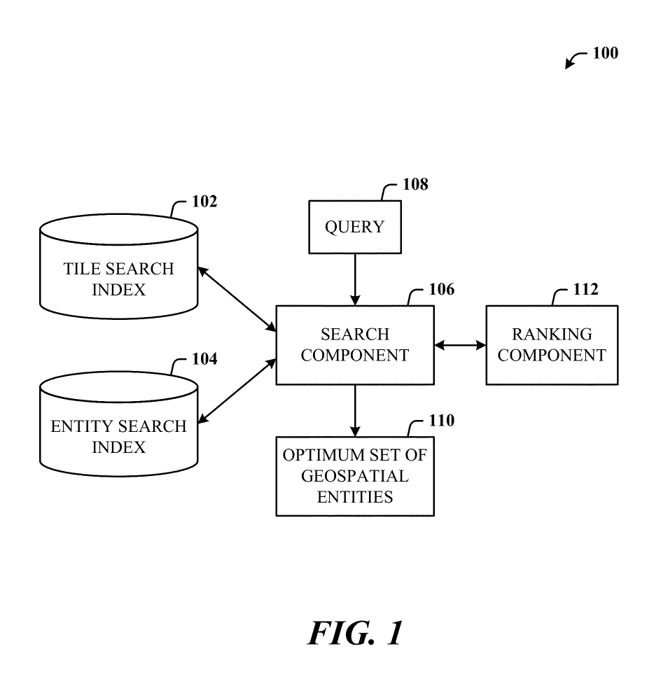

FIG. 1 illustrates a system 100 in accordance with the disclosed architecture. The system 100 can include a tile index 102 of tile documents that represent geospatial tiles of geographical locations and an entity index 104 of entity documents of geospatial entities associated with the tile documents and geospatial tiles.

A search component 106 searches the tile index and entity index as part of processing a query 108 for a geographical location. The search component 106 computes collocated entities in candidate geospatial tiles using the tile documents and returns an optimum set of geospatial entities 110 as results to the query 108.

The search component 106 employs text and geospatial search technologies to search the tile index and the entity index to identify the optimum set of geospatial entities 110 and associated geospatial tiles for the query 106. The search component 110 generates augmented queries of different augmentations to terms of the query 108 using tile identifiers. The search component 110 outputs the results as a geographical location and one or more entities associated with the geographical location.

Each of the tile documents are structured text documents that comprise attributes of entities that are connected to (intersecting or in close proximity of) the corresponding tile. Each of the collocated entities is associated with a geospatial tile and each of the geospatial entities is associated with multiple geospatial tiles. The tile documents represent tile hierarchies for differing tile sizes and differing densities of entities in corresponding geographical areas.

The system 100 can further comprise a ranking component 112 configured to rank potential geospatial tiles to select the candidate geospatial tiles and rank the entities to return the optimum set of geospatial entities 110 as the results. It is to be understood that in the disclosed architecture, certain components may be rearranged, combined, omitted, and additional components may be included.

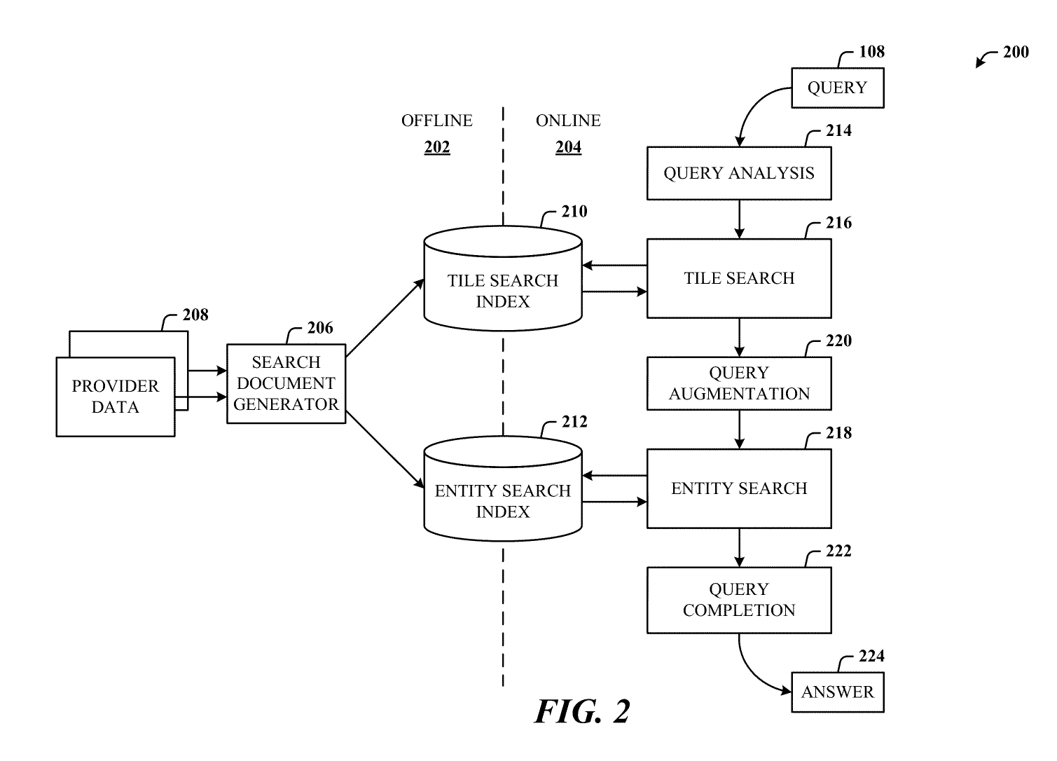

FIG. 2 illustrates a flow diagram 200 of a tile-based geocoder service in accordance with the disclosed architecture. The diagram 200 depicts both offline execution 202 and offline execution 204 of the geocoder service. Offline execution 202 covers high-level steps such as data acquisition and ingestion, schematization and ingestion into a search document generator 206, which generates the tile and entity search documents, constructing the search indexes, partitioning the indexes for efficient handling of updates, and relevance ranking model training

Online execution 204 covers high-level steps of query analysis flow (geospatial canonicalization, creating query interpretations, etc.) and query execution plan (QEP). The QEP relates to the issue of direct searches of popular places, if applicable, the issue of tile searches for each query interpretation, the normalization and ranking of tile search results, augmentation of the query with tile identification for a scoped entity search, the issue of entity searches for each tile scope, the normalization and ranking of entity search results, and the finalization of the query with found entities through re-ranking and spatial intersections.

With respect to a more detailed offline geocoding data flow for ingest and indexing, providers submit provider data 208 (geocode data) in the form of suitable schematization data documents. The provider data 208 comprises geocode entities, entity attributes and entity relationships in the form of provider data records. The provider data 208 may also incorporate market specific characteristics and rules such as variant names, ranking rules, etc. When this is not possible, the characteristics and/or rules can be referenced from existing markets (geographical areas such as countries).

The provider data 208, in a suitable schematization format data documents, are ingested into the search document generator 206. Geocode data is represented within the generator 206 as entities and relationships each with attached properties. The generator 206 ingestion process includes conflation (“Is the address point about to be created the same as one already existing in the generator?”), enrichment (“What is the routable point for this address?”; “What are the tiles to which this address point needs to be connected?”), delta updates (“What are the new/changed/removed addresses in this data drop?”), and versioning (“Here's a new <changeset> that was recently submitted into the generator: these are the new/changed/removed entities/properties/relationships in this drop.”).

More specifically, logic is provided that conflates entities coming from the different data providers. Records carrying similar properties and close locations are recognized as belonging to the same entity and represented as such in the generator 206. Additionally, logic is provided for the geospatial and geocoding enrichments to the data comprise variant name generation, routable points computation and, tile creation and mapping.

With respect to the online execution 204, the geocode runtime indexes comprise a tile index 210 and an entity index 212. Upon a detected change that occurs in the generator 206, an execution module is triggered to generate and update tile documents of the tile index 210 and entity documents of the entity index 212 (either or both of the indexes 210 or/and 212 can be inverted indexes). This process includes determining the nature of the change (entities that were added/changed/removed, tiles that were impacted), building the impacted tile documents (additional categorization and indexing of well-known entities can occur here, e.g., “Pacific Ocean” is recognized as a well-known feature indexed separately), and updating the runtime search indexes (210 and 212) with the refreshed tile documents.

With respect to provider data 208 representation, the geocode data (provider data 208) can be provided to the generator 206 in the format of compatible documents, which makes the generator ingestion process generic and automatic. However, provider data 208 that may not be in the desired format can be processed through a software adapter (e.g., separate from or part of the generator 206) that translates the provider data 208 from one form (e.g., SQL (structured query language) databases, csv (comma separated variable) files, etc.) into the currently-desired format for hand-off to other processes of the generator 206.

In the generator 206, the geocode entities (with attributes) can be represented as graphically linked entities with associated properties. These entities can be related (linked) through relationships—specifically, the connection between each geocode entity and its attributes and the geospatial extent where it resides, or in other terms, the geocode tile. To capture entity data in the tile documents (geocode tiles), entities are related to tiles. An entity sphere of influence is a two-dimensional concept of entity area and entity prominence.

With respect to online activities, the query 108 is received for query analysis 214. In query analysis 214, query terms are split into a sequence of tokens. Most frequently, such a split (a query rewrite) can be done in a variety of ways. Then a separate search is performed initiated for every potential split.

Sometimes, terms can be fuzzily matched to potential attributes. The terms can be rewritten using a restriction to in-index synonyms and alternatives. If for a particular term its semantics are known (e.g., from an unquestionably confident structured call), this can be used (e.g., City:Seattle as opposed to just Seattle that can be name of a street).

With respect to collocation, terms of a query can point to a single entity (as in many western countries) or to multiple entities (as in many other countries). However, even a single entity such as a street name can be given in conjunction with a neighboring city name; therefore, referring to more than one (collocated) entity. Accordingly, a join can be performed by location. More specifically, it is not a requirement that the exact location has a common intersection; a neighborhood of locations with non-empty intersections is sufficient.

The runtime algorithm (online execution 204) searches for location first. Entities, among other attributes, have a location. Additionally, a dual representation is retained by locations that, in turn, refer to entities, and vice versa—entities are associated with attributes and tiles, and tiles are associated with attributes and entities. As a location unit, a tile is used, where the tile is a square on a map.

After query analysis 214, the runtime algorithm (the online execution 204) first attempts to find a relevant location using a tile search 216 to search the tile index 210. Thereafter, and only when finding a relevant location, the algorithm then looks for relevant entity (or entities) using an entity search 218 to search the entities index 212 (after query augmentation 220, described herein). In other words, the address query is not considered as finding an entity or entities subject to collocation considerations, but as finding a location (a tile, as may be denoted herein as loc) subject to query term considerations followed by finding entities constrained to found location thereafter. After entity search 218 is performed, query completion 222 is performed to ultimately output an answer 224.

With respect to tiles, the concept of a tile has two perspectives: links to entities, and the derived data. First, a tile (tile document) stores links to the entities (e.g., a country, a state or a province, cities or population places, roads, landmarks, lakes, parks, and so on) that have non-trivial intersection with the tile. Additional data is derived from the links Whatever this data is, to update it, access all entities to which a tile is linked and regenerate this data. Therefore, an update involves only local entities. Second, the derived data (attribute values of entities it is linked to tile) is associated with a tile. Thus, the tile is a textual document.

For example, if a tile intersects with the Lake Tahoe, word “Tahoe” can be added to a document of the tile. The tile document can be updated according to routine maintenance. For example, if a new entity is added, the few tiles that the entity touches (intersects) can be instantaneously updated: the tile documents get incremented with attributes of the new entity. Tiles can also overlap and/or have variable-sizes.

In offline execution 202, tile documents and corresponding attribute documents are generated. Then a tile index (e.g., inverted) is created to enable quick search of tile documents. In an inverted index, for example, with every attribute value (a keyword), a list of all the tile documents containing this value is retained.

In the online execution 204 (runtime), after the query 108 is analyzed (in query analysis 214), a search for a tile that contains as many query terms as possible is performed in the tile search 216. Thus, a search is issued to the set of all tile documents (corpus) using standard search and the tile index 210 (e.g., if inverted, it is inverted by tile text terms). A partial match of terms can be sufficient. The subset of matched terms T⊂{t₁, . . . , tₚ} and a found tile loc play a role of interpreted attributes B and geo shape G. When several such terms T,loc are found they can be ranked and for each tile loc required, entities can now be found.

With respect to ranking potential tiles, predictive machine learning tools (e.g., gradient boosting trees) can be utilized using relevance features. Such features can include tile population, neighborhood prominence, a number of businesses within the tile and/or their aggregate static ranks, scope of influence (e.g., tile with Louvre is much more likely to be requested from a far place than other tiles), and so on.

The features can be uploaded to the index (called meta-stream) in advance. In addition to tile-based features, query-tile features can also be employed. In particular, a viewport v and user location u leads to geo-relevance features: distance from a tile to a viewport and/or distance from a tile to a user location.

With respect to tile annotation, in addition to relevance features, tile documents can be supplied with additional terms.

Neighborhood boundaries. Users frequently get the city wrong: a tile can contain not only the name of the city to which it belongs, but of a neighboring close city as well. This improves recall.

Colloquial names. Neighborhoods have colloquial names, (e.g., “downtown”, “SOMA”).

Term categories. The search engine can treat documents not just as a bag of words, but to distinguish different compartments/categories (e.g., anchor-text term plays a more important role than document body term). This option can be utilized by emphasizing significance of a term with known semantics (e.g., City:Vienna is stronger than just Vienna).

Real-time features. Real-time features (e.g., “a police action in progress”, “a fire”, “no parking available”, “airport is closed”, etc.) can be added. Thus, a tile can be considered a real-time volatile portrait of a fraction of the earth.

3D features. Tiles can be annotated with 3D features (e.g., a subway or multi-store construction).

Non-entity features. Non-entity feature comprise dignitary names, “unpronounceable volcano”, tourist information, and so on.

Web features. If a web page refers to a location within a tile, the tile can be linked to such a web page.

Advertisement. A tile is n suitable real-estate for employing advertisements.

With respect to finding entities, when a tile loc is found, it is known precisely which query terms T have been successfully matched and which entities are linked to a tile. A function FindEntities finds entities having terms T and constrained to a tile loc.

In summary, rather than looking for entities, a particular tile is searched, which, in turn, provides an easier way to search for entities. As written in pseudo-code, the GCS can be the following:

```
1. R = GCS (q,v,u)
2. Inputs: textual query q = (q₁ ... qₙ),viewport v, user location u
3. Outputs: a sorted set of results R = {Rⱼ,j = 1:s}
4. R = Ø
5. Analyze query q: generate several term rewrites q = (t₁^{j},...,tₚⱼ^{j}),
    j = 1:J
6. for j = 1 ... J
7. find partial matches T_{q}^{j} ⊂
    {t₁^{j},...,tₚ_{ⱼ}^{j}} to ranked tile τ_{q}^{j} using Bing search in tile corpus
8. end for
9. Sort all τ_{q}^{j} into a single list τₛ
10. for each s
11. {R₁,...,Rₖ} = FindEntities (q,τⱼ)
12. R = R ∪ {R₁,...,Rₖ}
13. end for
14. Dedupe and (Re)rank set R
15. return R
```

Entities, and in particular, points of interests (particular addresses with latitude and longitude data) can be viewed exactly as text documents. Therefore, the entities and points of interest can be indexed alongside the tiles. If a single such object is found, its relevance is pretty high, and many western queries may result in such single object.

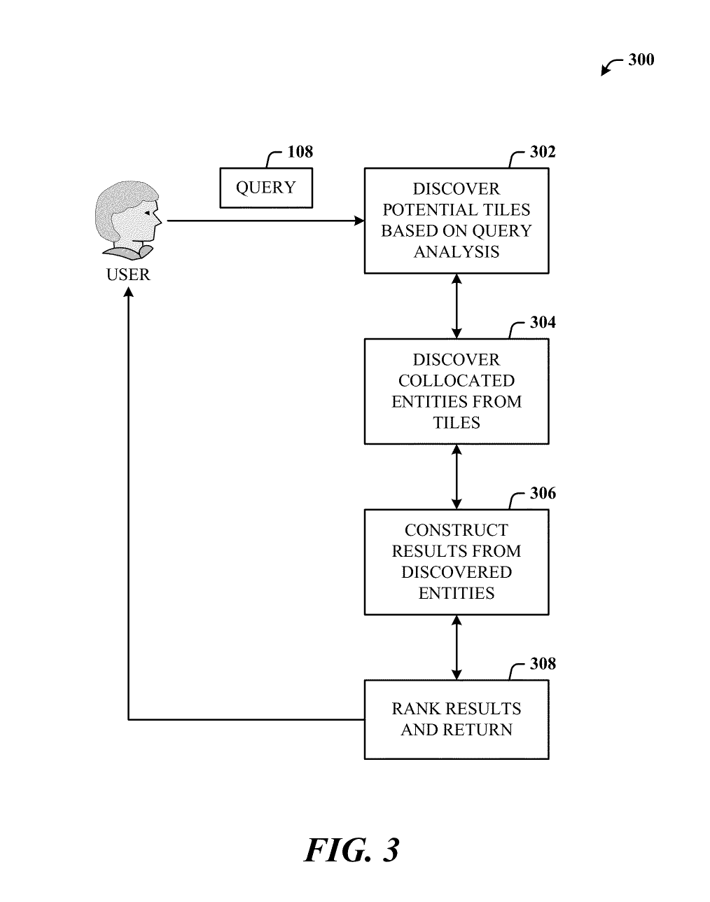

FIG. 3 illustrates is a general flow diagram 300 of the online execution algorithm of the geocoder service. Once the query 108 is received from the user, potential tiles are discovered based on query analysis, as indicated at 302. At 304, collocated entities are then discovered from the tiles. At 306, results are constructed from the discovered entities. At 308, the results are ranked and returned to the user.

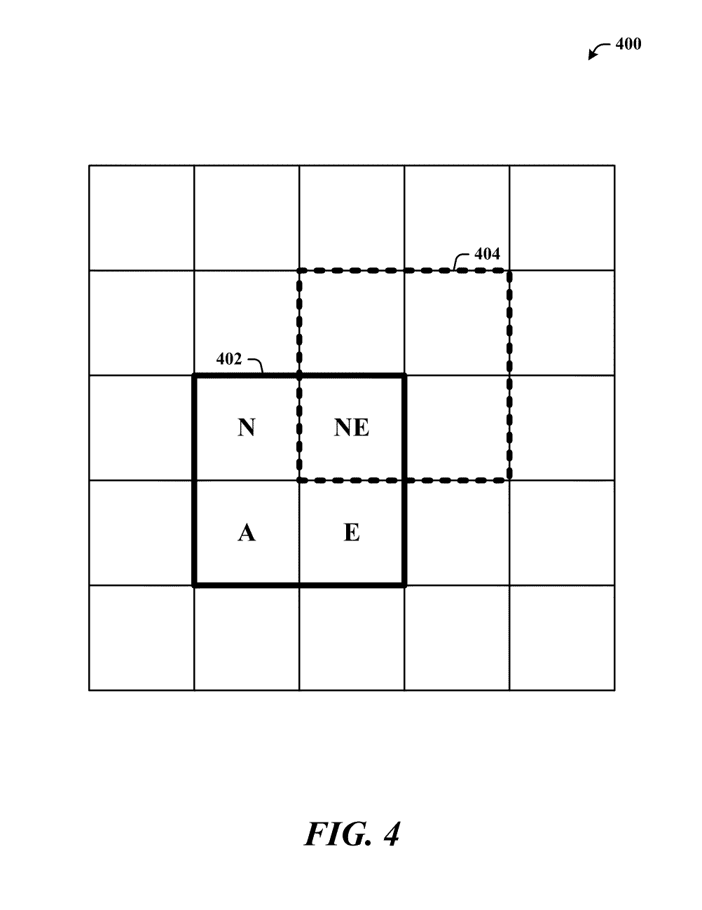

FIG. 4 illustrates a tile system 400 of overlapping tiles for the tile geocoding service. In one implementation, the B-tile can be a map tile with dimensions of approximately 1.2 km×1.2 km (at the equator). This provides a reasonable scale for the concept of proximity. While 1 km proximity is a reasonable scale for proximity, two very close entities can be located on two sides of a tile boundary. This provides motivation to deal with overlapping 2 km×2 km tiles, since these tiles guarantee that entities located within 1 km distance will end up in one such tile.

As previously indicated, LoD15 tile identification can be utilized and a tile entity set of entities that intersect with an actual tile A, as well as with the associated three neighboring tiles: a North-neighboring tile (N), an East-neighboring tile (E), and a NE-neighboring tile (NE), are included in the tile document associated with the actual tile A. In this way, de-facto B-tile overlapping tiles of size LoD14 are obtained, but enumerated by LoD15 quad keys. In other words, the actual tile A (the associated tile document) includes entities from a square area 402 bounded by a bold line. This area partially overlaps with another bounded square area 404 defined by a dotted line. The two overlapping tiles are the upper right (NE) tile of the area 402, and the lower left (SW) tile of the area 404.

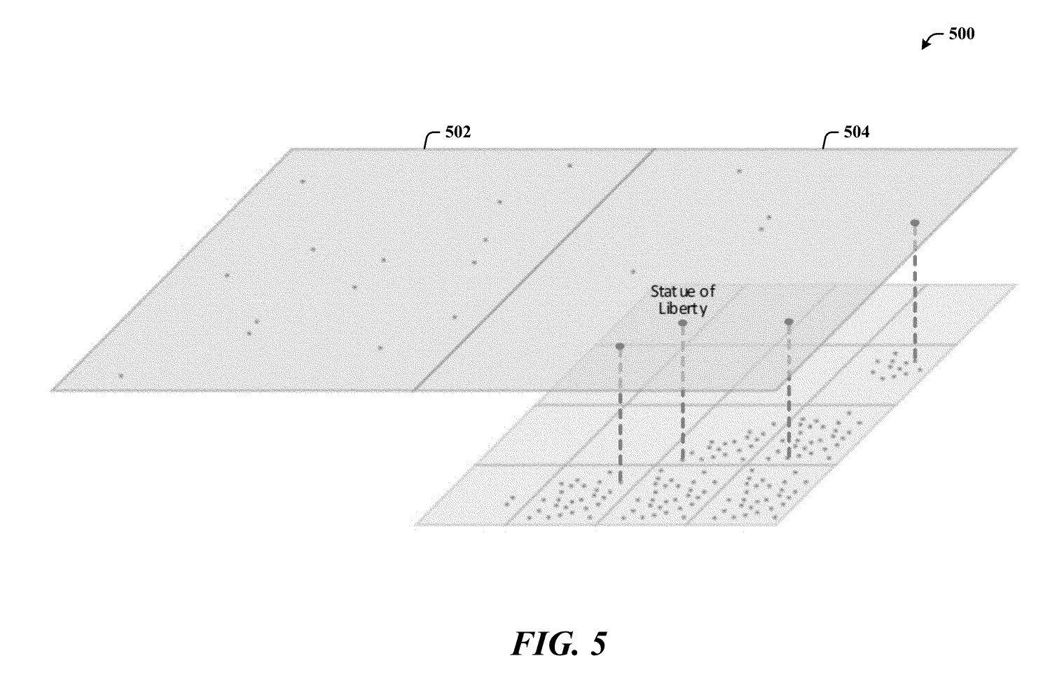

FIG. 5 illustrates a tile system 500 of different sized overlapping tiles for different densities, importance, and/or popularity of entities. As shown in FIG. 4, the space of the earth can be modeled as a grid of points at a unit of distance of each other. Centered on each point is a square unit of surface, referred to as a tile. In this approach each geospatial entity is covered by four tiles. Thus, there are at least one and at most four tiles covering every two entities within a unit of ground distance.

The tile system 500 enhances the model to also handle the different densities of entities in different parts of the world. For example, the spatial density of addresses in New York City is higher than the same density in a wide rural area in the State of Kansas. This differing density is addressed using hierarchical tile levels.

Hierarchical tile levels are applied on the same logic as the gridding described herein, but with wider unit of distance (e.g., 10 km×10 km, 100 km×100 km, etc.). The hierarchical layers enable geographic areas of low density of entities to be covered by a larger tile 502 (e.g., large tile on the left) and geographic areas of high density, the larger tiles capture high profile or popular entities, such as “Statue of Liberty” in New York City (e.g., large tile 504 on the right).

In the disclosed tiling system, two entities are considered to be “near each other” if the entities are collocated in at least the same tile. As such, the system covers the different understandings of “nearness” in different areas of density. For example, “Coffee Shop near Great Bend, KC” will return quickly to the closest coffee shop from the city, twenty-eight miles away by finding a low-resolution tile (100 km×100 km) covering both the city and the coffee shop. Similarly, “Coffee Shop near Empire State Building, NYC” is resolved quickly to the coffee shop a block away from the building by finding a high-resolution tile (e.g., 2 km×2 km) covering both the coffee shop and the Empire State Building.

At the individual tile level, each tile has two associated concepts. A tile (tile document) stores links to entities (e.g., a country, a state or a province, cities or population places, roads, landmarks, lakes, parks, businesses, etc.) that have non-trivial intersection with the tile. Additional data is derived from the links. The data is updated by accessing all entities to which a tile is linked and regenerating this data. Therefore, an update involves only local entities. In addition, a tile can also have bi-directional links to places where the tile is referred to in inverted indices defined below. This arrangement is employed to keep tile system updatable by new emerging data.

The derived data is associated with a tile (in the tile document). The derived data includes attribute values of linked entities. From this standpoint, a tile is a textual document. A tile intersecting an entity includes the entity in its tile document. The tile text documents can be searched, using, for example, an inverted index of tiles. Thus, with every potential query term such as, for example, “Tahoe”, a list of tiles that contain the term are associated with the tile: for example, all tiles that intersect with Lake Tahoe, and also tiles (tile documents) that contain Tahoe Hotel, Tahoe restaurant, Tahoe Elementary School, and so on. Moreover, to facilitate broad recognition of user queries, not only are attributes of canonical names added to the tile documents, but variants and local names as well.

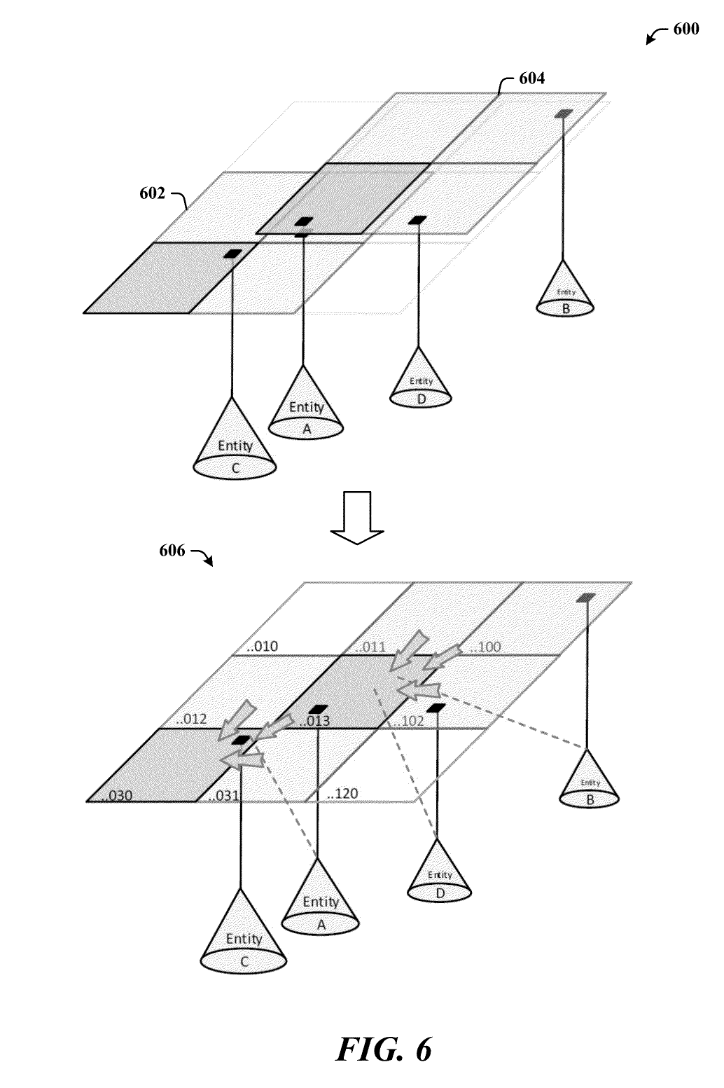

FIG. 6 illustrates a tile diagram 600 of hierarchical tile organization and keys. Each of the tiles (e.g., 1×1) has in its associated tile document attributes of entities from a wider ground area (e.g., a 2×2 square), for which the tile itself is the SW (lower left) corner. In this organization, the earth is covered in an overlapped manner such that each entity has its attributes indexed in four 1×1 tiles. Additionally, there is a tile (tile document) containing attributes from any arbitrary two entities geospatially within a one unit of distance (collocated entities).

The model above can be implemented as a 1×1 grid of tiles addressed through the well-established VETS (virtual earth tile system) quadkey addressing scheme at the chosen LoDs. For instance, an LoD 15 tile can be identified as a 15-digit quadkey. For each of these tiles, the tile-documents index attributes from all entities spatially located within the tile and/or in the neighboring tiles from N, NE and E directions, as depicted in FIG. 4.

In this example, a tile document for a tile set 602 of four tiles includes an Entity C for the lower-left tile and an Entity A in the upper-right tile. An overlapping tile set 604 of four tiles has a tile document that includes an Entity D in the lower-right tile, an Entity B in the upper-right tile, and the Entity A in the lower-left tile. The Entity A is covered by two tiles: the upper-right tile of the tile set 602 and the lower-left tile of the tile set 604.

In the rendering 606, the tile quadkey identification scheme is described. The tile document for tile . . . 030 (the lower-left tile of the tile set 602) collocates attributes from both Entity A and Entity C. The tile with quadkey . . . 013 collocates attributes from Entities A, D, and B; more explicitly, tile . . . 013 essentially covers entities from tiles . . . 013, . . . 102, . . . 011, . . . 100. In an alternative implementation, Cartesian coordinates can be utilized for tile . . . 013 to cover area 1≦x≦3, 1≦y≦3, which is a 2×2 square centered around point (2,2). Similarly, tile . . . 120 covers the 2×2 area centered around (3,1).

Assuming Entity A is matching a query term x and Entity C a query term y, then a query such as “x near y” resolves in the tile corpus to tile . . . 030. Assuming Entity C is matching a query term w and Entity B is matching a query term v, then a query such as “w near v” appears to not have a resolution in the tile corpus, since the matching entities are too far apart; hence, there is no tile document that collocates both attributes. To address such a situation, 1×1 tiles can be pyramided into higher level tiles (e.g., 8×8, 64×64, etc.).

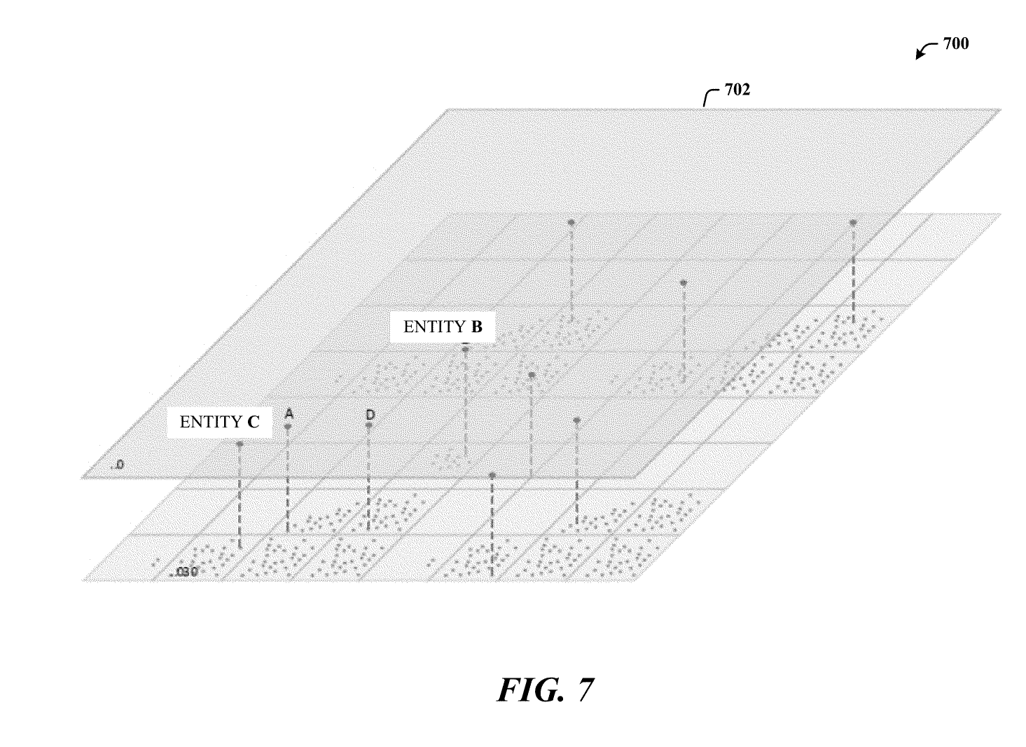

FIG. 7 illustrates a tile diagram 700 where entities of higher importance or popularity are pyramided into a single larger tile. Assuming Entities B and C, in the example, are sufficiently relevant to have associated prominence boosted at a higher level, their attributes will then be collocated in the larger tile 702 (denoted as . . . 0), thereby enabling resolution for the “w near v” query. The VETS addressing scheme enables neighboring tile determination both in terms of area and in terms of LoD.

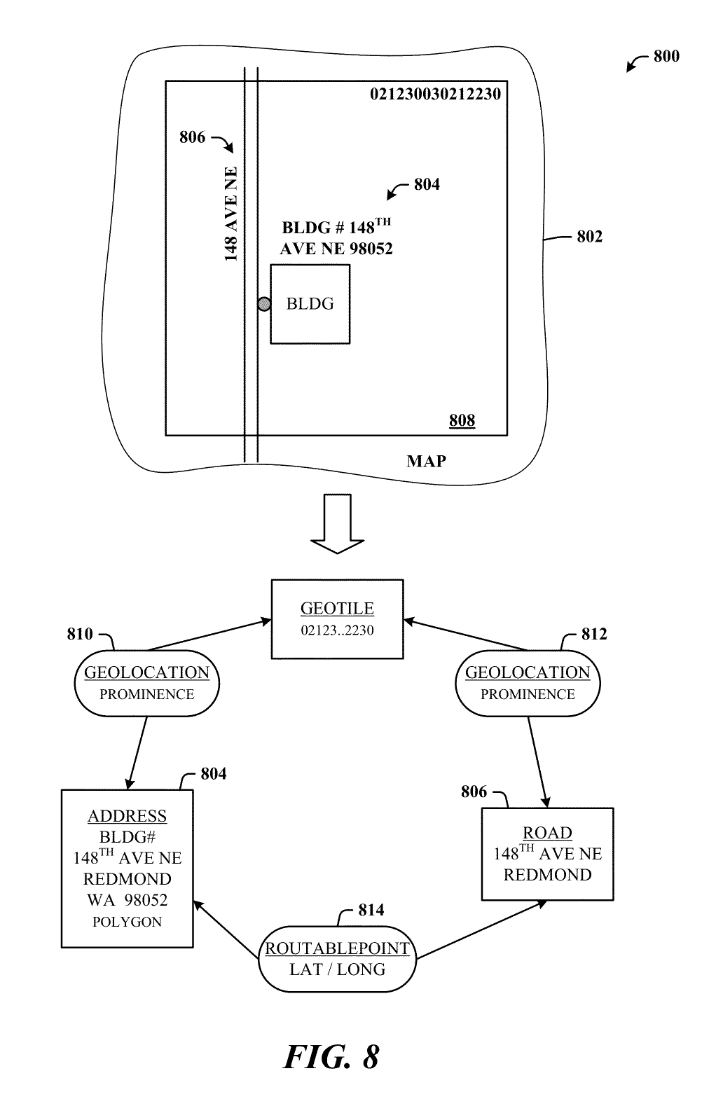

FIG. 8 illustrates a system 800 where relationships are stored in a tile document. The area 802 above depicts two entities; an address 804 (e.g., BLDG #148^{th} Ave NE 98052) and a road 806 (e.g., 148^{th} Ave NE) both in the area of one geo-tile (geocode tile) 808 (also denoted 021230030212230). The connection to the geocode tile 808 is reflected via “GeoLocation” relationships 810 and 812. Additionally the address 804 may be related to the road 806 directly via a “RoutablePoint” relationship 814. This model enables the connection of each entity not only to the overlapping tile as in the area 802 above, but with the N, E and NE adjacent tiles as well.

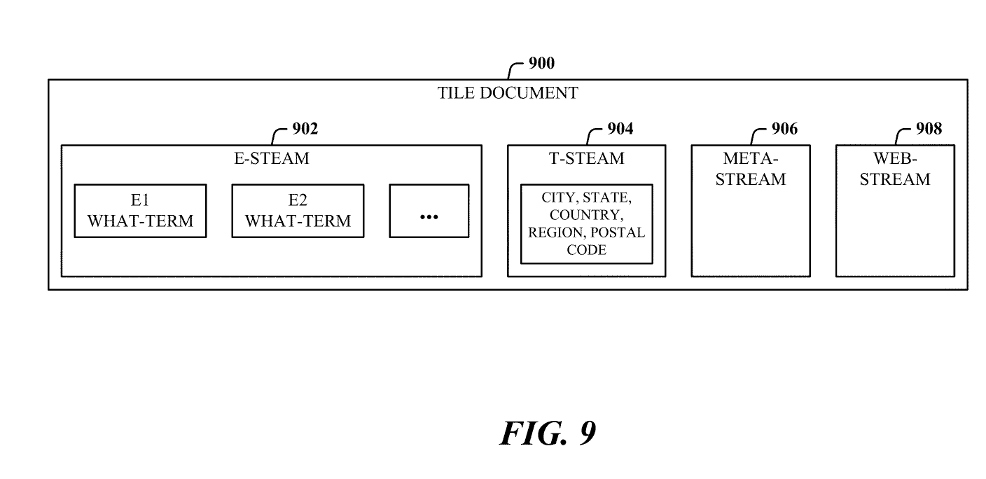

FIG. 9 illustrates an exemplary tile document 900. Essentially, a tile document is a concatenation of entity documents. Consider, for example, a Seattle tile. Every entity in this tile has “Seattle, Wash.” as a part of its structured address. Repeating such common terms with every entity adds entries to the tile index. Such common terms characterize not so much an entity, but more a tile itself. In our example, terms “Seattle” and “WA” characterize the limited number of tiles covering Seattle.

The frequent location attributes specific to a tile can be referred to as T-terms. T-terms are a mechanism for “tagging” tiles with specific predetermined knowledge about tile location. T-terms include names of large cities, counties, states, regions, or countries, for example. Entity terms, other than T-terms, can be referred to as E-terms. Entity terms occur in particular entities and vary from entity to entity. For example, an entity “Port of Seattle Headquarters, 2711 Alaskan Way, Seattle, Wash. 98121” consists of the E-terms “Port of Seattle Headquarters, 2711 Alaskan Way” and of T-terms “Seattle, Wash. 98121”. Notice the dual role of the term “Seattle”—it occurs twice, as an E-term and as a T-term.

When forming the tile document 900, in one implementation only E-terms of entity documents are concatenated—the T-terms can be aggregated separately. In other words, the tile document 900 will have more than one section or zone (also referred to as streams).

An E-stream 902 comprises concatenated entity E-terms for entities intersecting with a tile. A T-stream 904 comprises location attributes common to entities in the tile 900. The category descriptors (e.g., “gas station” or “park”) or road types (e.g., “way” or “Avenue”) are frequent in many tiles, but are not specific to any particular tile and, therefore, do not belong in a T-stream. Frequent location attributes such as county or postal codes are specific to several particularly located tiles and, thus, do belong to T-stream.

A meta-stream 906 comprises some one or more terms that can assist in search focus, and includes some markup. A goal of query enrichment and search in more than one corpus is to focus the search. Frequently, the best result is a popular global entity or entities located in a prominent area. On the other hand, many queries are local: either a user has an active viewport or a viewport can by implied. For example, a viewport can be set to a certain box around the user location. The same is true in vertical maps if the viewport is set to the default. Globally prominent and locally close results constitute two ways to focus the search.

To focus search on globally prominent results, some tiles can be marked with a meta-term (e.g., GLOBAL) in their meta-stream. Only a small portion of tiles are marked. Therefore, the posting list for the meta-term is relatively small. Adding this meta-term to a query focuses the search on a small portion of global tiles.

To focus search on local results, assume that a viewport and user location are present. It is desired to focus the search on results close to the user location and/or viewport. Additional focus on local results can be achieved using a relevance approach based on distance features, and filtering approach based on extra meta-words that identify desirable “local” tiles.

A web-stream 908 enables the generalization of GCS. The web-stream comprises data coming not from geo-entities, but from other sources of information, for example dignitary names, tourist information, security information, near real-time events (e.g., police action in progress), particular advertisement tags for targeting a specific tile, and web links to pages referring to entities within a tile.

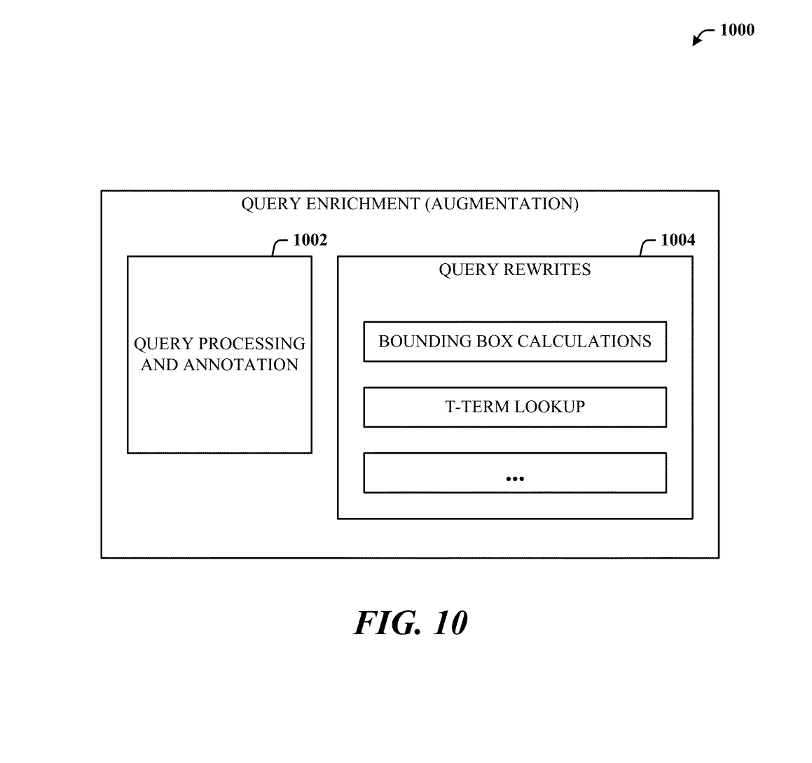

FIG. 10 illustrates a system 1000 of query enrichment. Query enrichment and augmentation are used interchangeably herein. The query enrichment phase consists of query processing and annotation 1002 and query rewrites 1004. The query processing and annotation 1002 step processes such things as stop words, spell correction, and synonyms, for example. In query rewrites 1004, a query is rewritten into several alternatives to be executed separately. The alternatives include:

1. Query itself as resulted from the first step: Q

2. Query augmented with meta-term indicating most popular tiles: Q, GLOBAL

3. Query augmented one or more hyper-tiles localizing the search: Q, H₁, . . . , H_{S}

4. Query in which some terms are marked as T-terms: Q^{T}

If a highly relevant result(s) is found, the general-purpose search can be terminated or severely restricted. Finally, there are many tiles containing the E-term “Chicago” (coming from entities such as “Chicago Title”, “Chicago restaurant” or “Chicago Ave.”), but very few containing “Chicago” as a T-term. Assume it was determined that a term “Chicago” in a query is a T-term. This significantly reduces the search space since the focus is only on the T-Stream.

If a query is short, the query can be checked to see if it is a navigational query that is referring entirely to a T-entity. A T-index lookup can solve a recall issue. The relevance can be judged later.

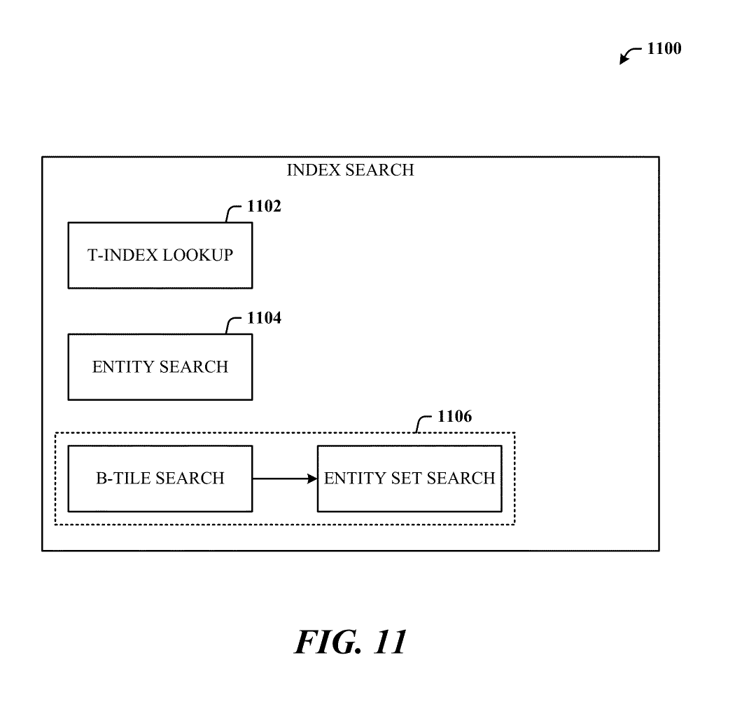

FIG. 11 illustrates an index search system 1100. As previously indicated, for a short query the T-corpus can be checked if a query is completely a navigational query. However, a large portion of all GC queries typically point to addresses, businesses, places, and combinations thereof.

The standard GCS two-step process [query→tile→entity] enables fulfillment of multi-pointer queries by finding collocated entity combinations. However, if a query actually points to a single entity, the two-step solution may result in some overhead. Consider a query “San Francisco restaurant Paris”. There are two matches to it: “Little Paris, 1131 Stockton Str, San Francisco, Calif., USA” and “Restaurant San Francisco, 1 Rue Mirabeau, 75016 Paris, France”. Finding these two single-entity results by first determining an appropriate tile can be expansive, since many tiles contain terms “San Francisco” and “Paris”. Meanwhile, resolving this query in the corpus of entities is almost trivial. Single-pointer queries constitute a large portion of GC queries and a dominant majority in some markets.

Therefore, as an alternative to the two-step process, search in a corpus of individual entities can be employed. Thus, three indices can be utilized: a T-index lookup 1102, an entity search 1104, and a B-tile to entity search 1106:
T-index of T-objects formed of Admin-0-3 entities (stored in memory)
E-tile index of individual entities (postal addresses, roads, places, and businesses)
B-index—an index of B-tiles (documents produced of concatenated entities)
   Both E- and B-tile indices have E-streams, T-streams, Meta-streams, and Web-streams. In particular, the meta-stream can contain meta-terms GLOBAL, or IDs of H-tiles (hierarchy tiles). Entity documents, in addition, carry the meta-terms of B-tiles to which the documents belong.

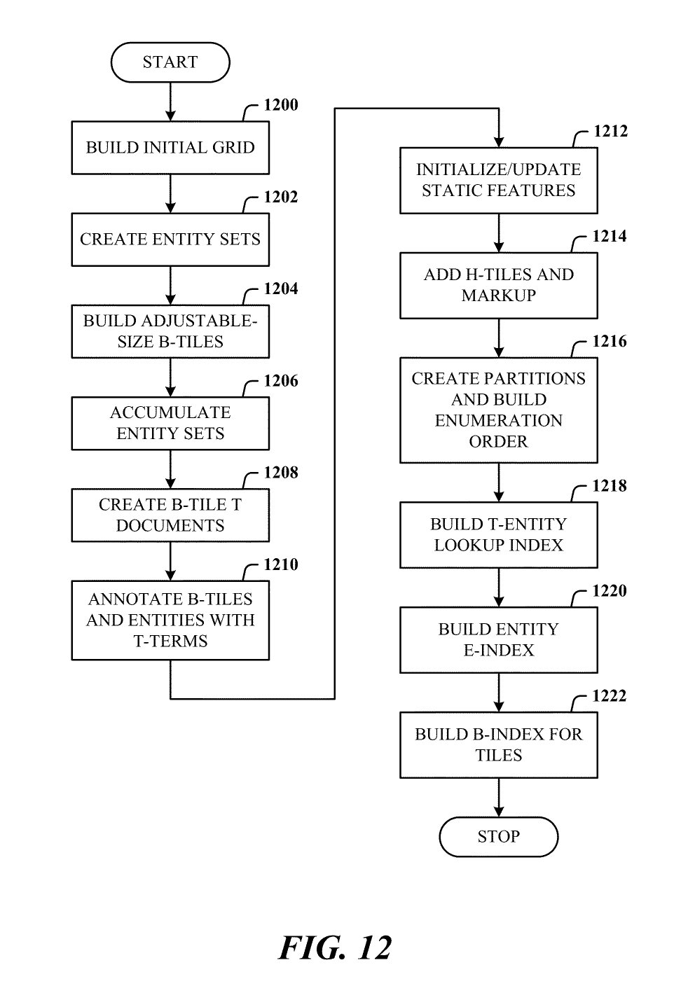

FIG. 12 illustrates a flow diagram of an offline execution phase of the GCS. At 1200, the initial grid of overlapping tiles is built. At 1202, entity sets (N(T) are created of entities with tiles T. At 1204, adjustable size b-tiles are built. At 1206, entity sets E(T) are accumulated from T-, N-, E-, NE-N(T). At 1208, B-tile T documents are created. At 1210, the B-tiles and entities are annotated with T-terms.

At 1212, static features are initialed and/or updated. Static features include, but are not limited to, popularity, click-through-rate, availability of public transportation, area prominence/safety, open hours, presence of the phone, ratings or closeness to a shopping mall for businesses, class of a road for roads, and so on.

At 1214, H-tiles and markup (e.g., GLOBAL) are added. At 1216, partitions are created and the enumeration order is built. At 1218, the T-entity lookup index is built. At 1220, the entity E-index is built. At 1222, the B-index is built for the tiles.

With respect to query matching, candidate entity sets matching a query Q are built. The different candidate entity sets can be built by matching query terms one by one. This process results in a query matching tree. Initially, the tree comprises only the root. When finished, the tree leaves represent all potential candidate entity sets for the given query. Starting with a leftmost term q₁, several potential entities are matched. Each results in a tree branch growing from the root. With each new term qᵢ, new branches are added to tree nodes. The construction of a query matching tree is illustrated below on an example of a query:

Q=(q₁, . . . q₇).

In this example, it is assumed that each of the terms in the queries match several entities as below:

| | Entities matching |
|---|---|
| Query Term | the term |
| q₁ | e₁, e₃ |
| q₂ | e₁ |
| q₃ | e₇, e₉ |
| q₄ | e₁ |
| q₅ | e₁ |
| q₆ | e₇, e₁₁ |
| q₇ | e₁₁ |

Since q₁εe₁, e₃, the root has two children: a first child root R1 where e₁ is matching q₁ and a second child root R16 where e₃ is matching the term. Next, since there is only one entity matching term q₂, there is just one branch growing from the first root R1 and one branch growing from the second root R16 which lead to additional nodes and so on.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

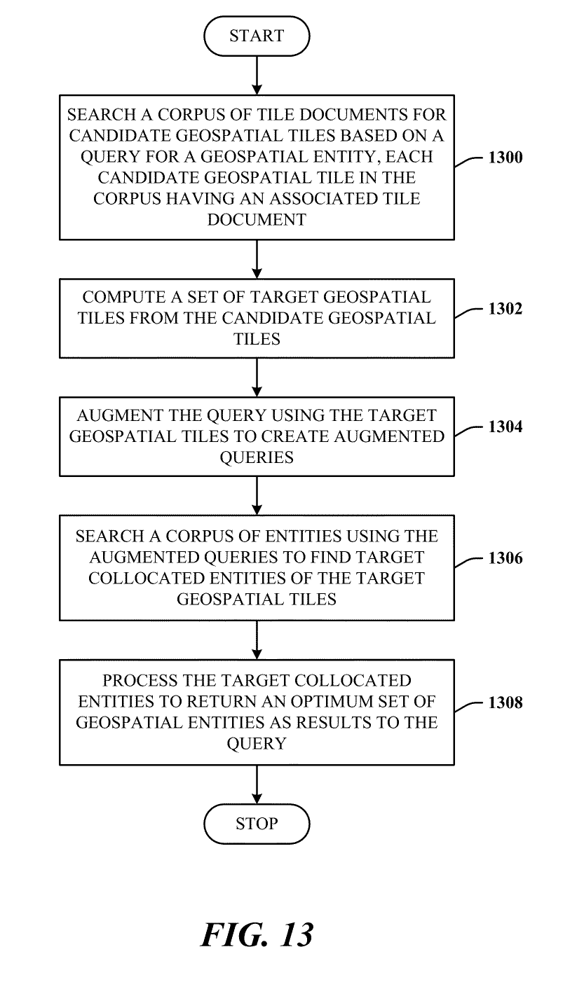

FIG. 13 illustrates a method in accordance with the disclosed architecture. At 1300, a corpus of tile documents is searched for candidate geospatial tiles based on a query for a geospatial entity, each candidate geospatial tile in the corpus having an associated tile document. At 1302, a set of target geospatial tiles is computed from the candidate geospatial tiles. At 1304, the query is augmented using the target geospatial tiles to create augmented queries. At 1306, a corpus of entities is searched using the augmented queries to find target collocated entities of the target geospatial tiles. At 1308, the target collocated entities are processed to return an optimum set of geospatial entities as results to the query.

The method can further comprise storing in the tile document attributes of entities that intersect the tile that are searchable. The act of augmenting can further comprise augmenting the query with tile identifiers used to search the corpus of entities. The method can further comprise processing the query into multiple different queries of correspondingly different sequences of n-grams.

The method can further comprise receiving with the query information that comprises at least one of a viewport or a user location. The method can further comprise structuring the corpus of tiles as set of overlapping tiles as defined in the associated tile documents. The method can further comprise structuring tiles in the corpus of tiles according to hierarchical tile levels.

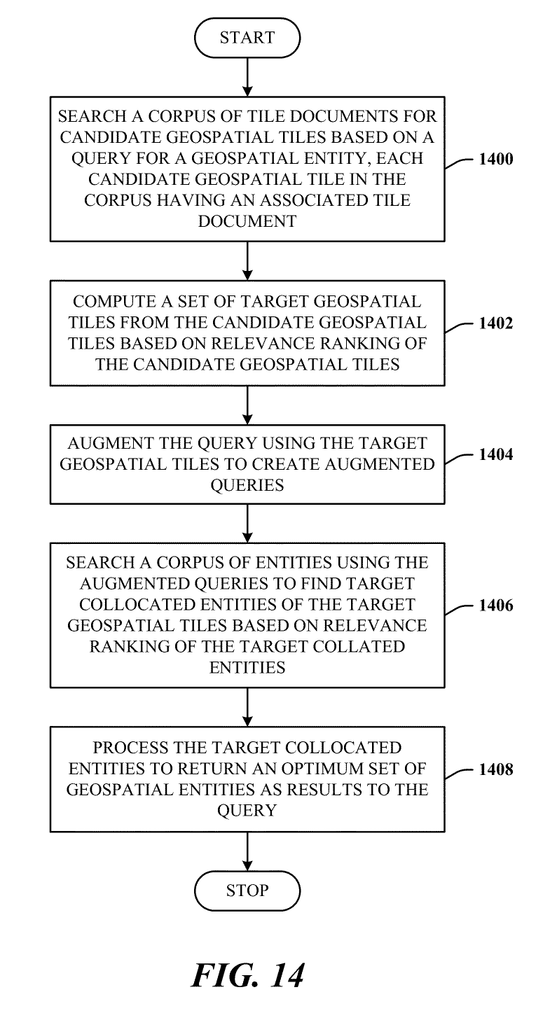

FIG. 14 illustrates an alternative method in accordance with the disclosed architecture. The method can be embodied as a computer-readable storage medium comprising computer-executable instructions that when executed by a hardware processor, cause the hardware processor to perform the following acts.

At 1400, a corpus of tile documents is searched for candidate geospatial tiles based on a query for a geospatial entity, each candidate geospatial tile in the corpus having an associated tile document. At 1402, a set of target geospatial tiles is computed from the candidate geospatial tiles based on relevance ranking of the candidate geospatial tiles. At 1404, the query is augmented using the target geospatial tiles to create augmented queries. At 1406, a corpus of entities is searched using the augmented queries to find target collocated entities of the target geospatial tiles based on relevance ranking of the target collated entities. At 1408, the target collocated entities are processed to return an optimum set of geospatial entities as results to the query.

The computer-readable storage medium can further comprise structuring the corpus of tiles as a set of overlapping tiles as defined in the associated tile documents and structuring tiles in the corpus of tiles according to hierarchical tile levels. The computer-readable storage medium can further comprise representing tile hierarchies for differing tile sizes and differing densities of entities in corresponding geographical areas in the tile document of the corpus of tile documents.

The computer-readable storage medium can further comprise representing entities and entity attributes in an entity document of the corpus of entities. The computer-readable storage medium can further comprise receiving as an input to a search service that performing the searching, at least one of the query as a textual query, a viewport, or a user location.

As used in this application, the terms “component” and “system” are intended to refer to a computer-related entity, either hardware, a combination of software and tangible hardware, software, or software in execution. For example, a component can be, but is not limited to, tangible components such as a microprocessor, chip memory, mass storage devices (e.g., optical drives, solid state drives, and/or magnetic storage media drives), and computers, and software components such as a process running on a microprocessor, an object, an executable, a data structure (stored in a volatile or a non-volatile storage medium), a module, a thread of execution, and/or a program.

By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

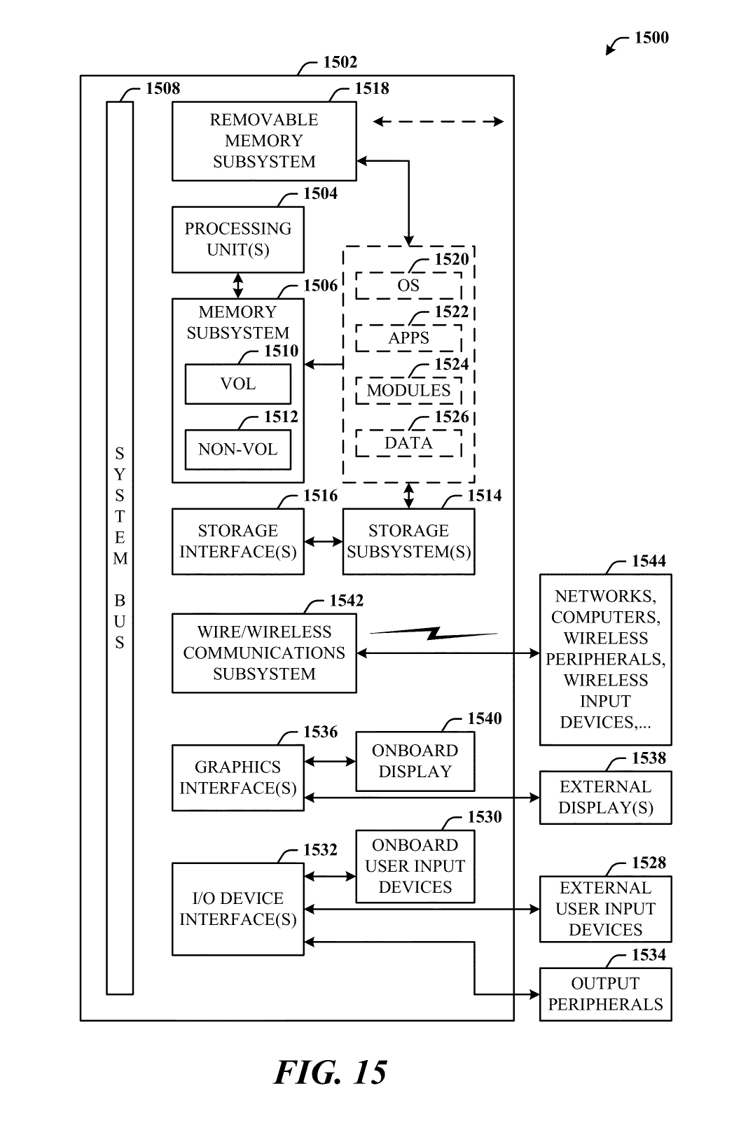

Referring now to FIG. 15, there is illustrated a block diagram of a computing system 1500 that executes the geocode service in accordance with the disclosed architecture. However, it is appreciated that the some or all aspects of the disclosed methods and/or systems can be implemented as a system-on-a-chip, where analog, digital, mixed signals, and other functions are fabricated on a single chip substrate.

In order to provide additional context for various aspects thereof, FIG. 15 and the following description are intended to provide a brief, general description of the suitable computing system 1500 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 1500 for implementing various aspects includes the computer 1502 having microprocessing unit(s) 1504 (also referred to as microprocessor(s) and processor(s)), a computer-readable storage medium such as a system memory 1506 (computer readable storage medium/media also include magnetic disks, optical disks, solid state drives, external memory systems, and flash memory drives), and a system bus 1508. The microprocessing unit(s) 1504 can be any of various commercially available microprocessors such as single-processor, multi-processor, single-core units and multi-core units of processing and/or storage circuits. Moreover, those skilled in the art will appreciate that the novel system and methods can be practiced with other computer system configurations, including minicomputers, mainframe computers, as well as personal computers (e.g., desktop, laptop, tablet PC, etc.), hand-held computing devices, microprocessor-based or programmable consumer electronics, and the like, each of which can be operatively coupled to one or more associated devices.

The computer 1502 can be one of several computers employed in a datacenter and/or computing resources (hardware and/or software) in support of cloud computing services for portable and/or mobile computing systems such as wireless communications devices, cellular telephones, and other mobile-capable devices. Cloud computing services, include, but are not limited to, infrastructure as a service, platform as a service, software as a service, storage as a service, desktop as a service, data as a service, security as a service, and APIs (application program interfaces) as a service, for example.

The system memory 1506 can include computer-readable storage (physical storage) medium such as a volatile (VOL) memory 1510 (e.g., random access memory (RAM)) and a non-volatile memory (NON-VOL) 1512 (e.g., ROM, EPROM, EEPROM, etc.). A basic input/output system (BIOS) can be stored in the non-volatile memory 1512, and includes the basic routines that facilitate the communication of data and signals between components within the computer 1502, such as during startup. The volatile memory 1510 can also include a high-speed RAM such as static RAM for caching data.

The system bus 1508 provides an interface for system components including, but not limited to, the system memory 1506 to the microprocessing unit(s) 1504. The system bus 1508 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 1502 further includes machine readable storage subsystem(s) 1514 and storage interface(s) 1516 for interfacing the storage subsystem(s) 1514 to the system bus 1508 and other desired computer components and circuits. The storage subsystem(s) 1514 (physical storage media) can include one or more of a hard disk drive (HDD), a magnetic floppy disk drive (FDD), solid state drive (SSD), flash drives, and/or optical disk storage drive (e.g., a CD-ROM drive DVD drive), for example. The storage interface(s) 1516 can include interface technologies such as EIDE, ATA, SATA, and IEEE 1394, for example.

One or more programs and data can be stored in the memory subsystem 1506, a machine readable and removable memory subsystem 1518 (e.g., flash drive form factor technology), and/or the storage subsystem(s) 1514 (e.g., optical, magnetic, solid state), including an operating system 1520, one or more application programs 1522, other program modules 1524, and program data 1526.

The operating system 1520, one or more application programs 1522, other program modules 1524, and/or program data 1526 can include items and components of the systems, flow diagrams, documents, and so on described herein, for example.

Generally, programs include routines, methods, data structures, other software components, etc., that perform particular tasks, functions, or implement particular abstract data types. All or portions of the operating system 1520, applications 1522, modules 1524, and/or data 1526 can also be cached in memory such as the volatile memory 1510 and/or non-volatile memory, for example. It is to be appreciated that the disclosed architecture can be implemented with various commercially available operating systems or combinations of operating systems (e.g., as virtual machines).

The storage subsystem(s) 1514 and memory subsystems (1506 and 1518) serve as computer readable media for volatile and non-volatile storage of data, data structures, computer-executable instructions, and so on. Such instructions, when executed by a computer or other machine, can cause the computer or other machine to perform one or more acts of a method. Computer-executable instructions comprise, for example, instructions and data which cause a general purpose computer, special purpose computer, or special purpose microprocessor device(s) to perform a certain function or group of functions. The computer executable instructions may be, for example, binaries, intermediate format instructions such as assembly language, or even source code. The instructions to perform the acts can be stored on one medium, or could be stored across multiple media, so that the instructions appear collectively on the one or more computer-readable storage medium/media, regardless of whether all of the instructions are on the same media.

Computer readable storage media (medium) exclude (excludes) propagated signals per se, can be accessed by the computer 1502, and include volatile and non-volatile internal and/or external media that is removable and/or non-removable. For the computer 1502, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

A user can interact with the computer 1502, programs, and data using external user input devices 1528 such as a keyboard and a mouse, as well as by voice commands facilitated by speech recognition. Other external user input devices 1528 can include a microphone, an IR (infrared) remote control, a joystick, a game pad, camera recognition systems, a stylus pen, touch screen, gesture systems (e.g., eye movement, body poses such as relate to hand(s), finger(s), arm(s), head, etc.), and the like. The user can interact with the computer 1502, programs, and data using onboard user input devices 1530 such a touchpad, microphone, keyboard, etc., where the computer 1502 is a portable computer, for example.

These and other input devices are connected to the microprocessing unit(s) 1504 through input/output (I/O) device interface(s) 1532 via the system bus 1508, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 1532 also facilitate the use of output peripherals 1534 such as printers, audio devices, camera devices, and so on, such as a sound card and/or onboard audio processing capability.

One or more graphics interface(s) 1536 (also commonly referred to as a graphics processing unit (GPU)) provide graphics and video signals between the computer 1502 and external display(s) 1538 (e.g., LCD, plasma) and/or onboard displays 1540 (e.g., for portable computer). The graphics interface(s) 1536 can also be manufactured as part of the computer system board.

The computer 1502 can operate in a networked environment (e.g., IP-based) using logical connections via a wired/wireless communications subsystem 1542 to one or more networks and/or other computers. The other computers can include workstations, servers, routers, personal computers, microprocessor-based entertainment appliances, peer devices or other common network nodes, and typically include many or all of the elements described relative to the computer 1502. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 1502 connects to the network via a wired/wireless communication subsystem 1542 (e.g., a network interface adapter, onboard transceiver subsystem, etc.) to communicate with wired/wireless networks, wired/wireless printers, wired/wireless input devices 1544, and so on. The computer 1502 can include a modem or other means for establishing communications over the network. In a networked environment, programs and data relative to the computer 1502 can be stored in the remote memory/storage device, as is associated with a distributed system. It will be appreciated that the network connections shown are exemplary and other means of establishing a communications link between the computers can be used.

The computer 1502 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related technology and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a tile index of tile documents that represent geospatial tiles of geographical locations;
an entity index of entity documents of geospatial entities associated with the tile documents and geospatial tiles;
a search component configured to search the tile index and entity index as part of processing a query for a geographical location, the search component computes collocated entities in candidate geospatial tiles using the tile documents and returns an optimum set of geospatial entities as results to the query; and
at least one hardware processor configured to execute computer-executable instructions in a memory associated with the tile index, the entity index, and the search component.

2. The system of claim 1, wherein each of the tile documents are structured text documents that comprise attributes of entities that intersect with the corresponding tile.

3. The system of claim 1, wherein the search component employs text search technology to search the tile index and the entity index to identify the optimum set of geospatial entities and associated geospatial tiles for the query.

4. The system of claim 1, wherein the search component generates augmented queries of different augmentations to query terms using tile identifiers.

5. The system of claim 1, further comprising a ranking component configured to rank potential geospatial tiles to select the candidate geospatial tiles and rank the entities to return the optimum set of geospatial entities.

6. The system of claim 1, wherein each of the collocated entities is associated with a geospatial tile and each of the geospatial entities is associated with multiple geospatial tiles.

7. The system of claim 1, wherein the tile documents represent tile hierarchies for differing tile sizes and differing densities of entities in corresponding geographical areas.

8. The system of claim 1, wherein the search component outputs the results as a geographical location and one or more entities associated with the geographical location.

9. A method, comprising acts of:
searching a corpus of tile documents for candidate geospatial tiles based on a query for a geospatial entity, each candidate geospatial tile in the corpus having an associated tile document;
computing a set of target geospatial tiles from the candidate geospatial tiles;
augmenting the query using the target geospatial tiles to create augmented queries;
searching a corpus of entities using the augmented queries to find target collocated entities of the target geospatial tiles; and
processing the target collocated entities to return an optimum set of geospatial entities as results to the query.

10. The method of claim 9, further comprising storing in the tile document attributes of entities that intersect the tile that are searchable.

11. The method of claim 9, wherein the act of augmenting further comprises augmenting the query with tile identifiers used to search the corpus of entities.

12. The method of claim 9, further comprising processing the query into multiple different queries of correspondingly different sequences of n-grams.

13. The method of claim 9, further comprising receiving with the query information that comprises at least one of a viewport or a user location.

14. The method of claim 9, further comprising structuring the corpus of tiles as set of overlapping tiles as defined in the associated tile documents.

15. The method of claim 9, further comprising structuring tiles in the corpus of tiles according to hierarchical tile levels.

16. A computer-readable storage medium comprising computer-executable instructions that when executed by a hardware processor, cause the hardware processor to perform acts of:
searching a corpus of tile documents for candidate geospatial tiles based on a query for a geospatial entity, each candidate geospatial tile in the corpus having an associated tile document;
computing a set of target geospatial tiles from the candidate geospatial tiles based on relevance ranking of the candidate geospatial tiles;
augmenting the query using the target geospatial tiles to create augmented queries;
searching a corpus of entities using the augmented queries to find target collocated entities of the target geospatial tiles based on relevance ranking of the target collated entities; and
processing the target collocated entities to return an optimum set of geospatial entities as results to the query.

17. The computer-readable storage medium of claim 16, further comprising structuring the corpus of tiles as set of overlapping tiles as defined in the associated tile documents and structuring tiles in the corpus of tiles according to hierarchical tile levels.

18. The computer-readable storage medium of claim 16, further comprising representing tile hierarchies for differing tile sizes and differing densities of entities in corresponding geographical areas in the tile document of the corpus of tile documents.

19. The computer-readable storage medium of claim 16, further comprising representing entities and entity attributes in an entity document of the corpus of entities.

20. The computer-readable storage medium of claim 16, further comprising receiving as an input to a search service that performing the searching, at least one of the query as a textual query, a viewport, or a user location.
